(19) United States
(12) Patent Application Publication
(10) Pub. No.: US 2026/0199155 A1
(43) Pub. Date: Jul. 16, 2026

(54) ELECTRIC MOBILITY APPARATUSES, CONTROL METHODS, AND CONTROL SYSTEMS

(71) Applicant: SHENZHEN ZHIMAHUAERKAI TECHNOLOGY CO., LTD., Shenzhen (CN)

(72) Inventors: Qi YI, Shenzhen (CN); Jianjian ZENG, Shenzhen (CN); Xiaojun YANG, Shenzhen (CN)

(73) Assignee: SHENZHEN ZHIMAHUAERKAI TECHNOLOGY CO., LTD., Shenzhen (CN)

(21) Appl. No.: 19/558,393

(22) Filed: Mar. 5, 2026

Related U.S. Application Data
(63) Continuation of application No. PCT/CN2024/117626, filed on Sep. 7, 2024.

(30) Foreign Application Priority Data
Sep. 8, 2023 (CN) 202311163061.5
Jun. 21, 2024 (CN) 202410816705.4
Jul. 26, 2024 (CN) 202411018754.X
Jul. 29, 2024 (CN) 202411031660.6

(51) Int. Cl. A61G 5/04; A61G 5/08; A61G 5/10; B60L 15/20; B62B 5/00

(52) U.S. Cl. CPC A61G 5/041; A61G 5/0833; A61G 5/0866; A61G 5/10; B60L 15/20; B62B 5/0033; B62B 5/0073; B60L 2200/24; B60L 2200/34; B60L 2240/421; B60L 2240/423

(57) ABSTRACT

Provided are a control system and a control method for an electric mobility apparatus. The control method includes: obtaining input information of the electric mobility apparatus in a current operation mode; determining one or more control commands for the electric mobility apparatus based on the input information in the current operation mode; and controlling the electric mobility apparatus to perform one or more actions based on the one or more control commands.

### CROSS-REFERENCE TO RELATED APPLICATIONS

This application is a continuation of International Patent Application No. PCT/CN2024/117626, filed on Sep. 7, 2024, which claims priority of Chinese Application No. 202410816705.4, filed on Jun. 21, 2024, Chinese Application No. 202411018754.X, filed on Jul. 26, 2024, Chinese Application No. 202411031660.6, filed on Jul. 29, 2024, and Chinese Application No. 202311163061.5, filed on Sep. 8, 2023, the entire contents of each of which are incorporated herein by reference.

### TECHNICAL FIELD

The present disclosure relates to the technical field of mobility apparatus, and in particular, relates to an electric mobility apparatus, a control method and a control system for an electric mobility apparatus.

### BACKGROUND

Electric mobility apparatuses are apparatuses that are capable of moving using electricity as a power source. When using the electric mobility apparatuses, users hope to have a good experience and safety guarantees.

Therefore, it is desired to provide an electric mobility apparatus and a control method and a control system for an electric mobility apparatus, thereby facilitating folding of the electric mobility apparatus and enhancing user experience.

### SUMMARY

One or more embodiments of the present disclosure provide a control method for an electric mobility apparatus. The control method may include: obtaining input information of the electric mobility apparatus in a current operation mode; determining one or more control commands for the electric mobility apparatus based on the input information in the current operation mode; and controlling the electric mobility apparatus to perform one or more actions based on the one or more control commands.

One or more embodiments of the present disclosure provide a control system for an electric mobility apparatus. The control system may include: an information acquisition module configured to obtain input information of the electric mobility apparatus in a current operation mode; a command determination module configured to determine one or more control commands for the electric mobility apparatus based on the input information in the current operation mode; and a control module configured to control the electric mobility apparatus to perform one or more actions based on the one or more control commands.

One or more embodiments of the present disclosure provide an electric mobility apparatus including a processor. The processor may be configured to: obtain input information of the electric mobility apparatus in a current operation mode; determine one or more control commands for the electric mobility apparatus based on the input information in the current operation mode; and control the electric mobility apparatus to perform one or more actions based on the one or more control commands.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a structure of an electric mobility apparatus in an unfolded state according to some embodiments of the present disclosure;

FIG. 2 is a schematic diagram illustrating a structure of an electric mobility apparatus in an unfolded state observed from another view according to some embodiments of the present disclosure;

FIG. 3 is a left view illustrating an electric mobility apparatus in an unfolded state according to some embodiments of the present disclosure;

FIG. 4 is a left view illustrating an electric mobility apparatus during a folding process according to some embodiments of the present disclosure;

FIG. 5 is a left view illustrating an electric mobility apparatus in a folded state according to some embodiments of the present disclosure;

FIG. 6 is a left view illustrating an armrest of an electric mobility apparatus sliding backward to a position according to some embodiments of the present disclosure;

FIG. 7 is a left view illustrating an armrest of an electric mobility apparatus sliding forward to a position according to some embodiments of the present disclosure;

FIG. 8 is a schematic diagram illustrating a sliding connection between an armrest and an armrest bracket of an electric mobility apparatus via a slide groove according to some embodiments of the present disclosure;

FIG. 9 is an interior view illustrating an armrest of an electric mobility apparatus sliding backward along an armrest bracket to a limit position according to some embodiments of the present disclosure;

FIG. 10 is an interior view illustrating an armrest of an electric mobility apparatus sliding forward along an armrest bracket to a limit position according to some embodiments of the present disclosure;

FIG. 11 is a schematic diagram illustrating two positions of a pedal member of an electric mobility apparatus according to some embodiments of the present disclosure;

FIG. 12 is a schematic diagram illustrating a manner of using an electric mobility apparatus when the electric mobility apparatus passes through a step according to some embodiments of the present disclosure;

FIG. 13 is a schematic diagram illustrating positions of a first limiting member and a limiting pin of an electric mobility apparatus in an unfolded state according to some embodiments of the present disclosure;

FIG. 14 is a schematic diagram illustrating positions of a first limiting member and a limiting pin of an electric mobility apparatus in a folded state according to some embodiments of the present disclosure;

FIG. 15 is a schematic diagram illustrating a position of a releasing pedal when an electric mobility apparatus is in a limiting state according to some embodiments of the present disclosure;

FIG. 16 is a schematic diagram illustrating a position of a releasing pedal when an electric mobility apparatus is in a released state according to some embodiments of the present disclosure;

FIG. 17 is a schematic diagram illustrating a forward-facing position of handles of an electric mobility apparatus according to some embodiments of the present disclosure;

FIG. 18 is a schematic diagram illustrating a rearward-facing position of handles of an electric mobility apparatus according to some embodiments of the present disclosure;

FIG. 19 is a schematic diagram illustrating an inward-facing position of handles of an electric mobility apparatus according to some embodiments of the present disclosure;

FIG. 20 is a structural diagram illustrating a locking and unlocking mechanism of an electric mobility apparatus according to some embodiments of the present disclosure;

FIG. 21 is a schematic diagram illustrating cooperation between a locking tooth sleeve and a locking tooth block of a locking and unlocking mechanism that that restrict a handle of an electric mobility apparatus in a forward-facing position, a rearward-facing position, and an inward-facing positions, respectively, according to some embodiments of the present disclosure;

FIG. 22 is a structural diagram illustrating a locking tooth block of a locking and unlocking mechanism of an electric mobility apparatus according to some embodiments of the present disclosure;

FIG. 23 is a structural diagram illustrating a locking tooth sleeve of a locking and unlocking mechanism of an electric mobility apparatus according to some embodiments of the present disclosure;

FIG. 24 is a schematic diagram illustrating an angle between a backrest and a cushion of a foldable electric mobility apparatus in an unfolded state according to some embodiments of the present disclosure;

FIG. 25 is a schematic diagram illustrating a curved shape of a backrest of a foldable electric mobility apparatus in a horizontal direction according to some embodiments of the present disclosure;

FIG. 26 is a schematic diagram illustrating a structure of a foldable and portable electric mobility apparatus in an unfolded state according to some embodiments of the present disclosure;

FIG. 27 is a left view illustrating a foldable and portable electric mobility apparatus in an unfolded state according to some embodiments of the present disclosure;

FIG. 28 is a schematic diagram illustrating a structure of a foldable and portable electric mobility apparatus in a folded state according to some embodiments of the present disclosure;

FIG. 29 is a left view illustrating a foldable and portable electric mobility apparatus during folding according to some embodiments of the present disclosure;

FIG. 30 is a schematic diagram illustrating a structure of a foldable and portable electric mobility apparatus in a folded state according to some embodiments of the present disclosure;

FIG. 31 is a left view illustrating a structure of a foldable and portable electric mobility apparatus in an unfolded state according to some embodiments of the present disclosure;

FIG. 32 is a flowchart illustrating an exemplary control process for an electric mobility apparatus according to some embodiments of the present disclosure;

FIG. 33 is a flowchart illustrating an exemplary control process for an electric mobility apparatus according to some embodiments of the present disclosure;

FIG. 34 is a flowchart illustrating an exemplary process for determining a driving parameter according to some embodiments of the present disclosure;

FIG. 35 is a flowchart illustrating an exemplary process for determining a push mode according to some embodiments of the present disclosure;

FIG. 36A is a flowchart illustrating a state of a pushing handle according to some embodiments of the present disclosure;

FIG. 36B is a schematic diagram illustrating a state of a pushing handle according to some embodiments of the present disclosure;

FIG. 37 is a flowchart illustrating an exemplary process for adjusting a pushing handle according to some embodiments of the present disclosure;

FIG. 38 is a schematic diagram illustrating an exemplary mode selection device according to some embodiments of the present disclosure;

FIG. 39 is a schematic diagram illustrating an exemplary architecture of a control system for an electric mobility apparatus according to some embodiments of the present disclosure;

FIG. 40 is a schematic diagram illustrating an exemplary indication module according to some embodiments of the present disclosure;

FIG. 41 is a schematic diagram illustrating an exemplary structure of a control device for an electric mobility apparatus according to some embodiments of the present disclosure;

FIG. 42 is a flowchart illustrating an exemplary control process for an electric mobility apparatus according to some embodiments of the present disclosure;

FIG. 43 is a flowchart illustrating an exemplary process for determining a driving parameter according to some embodiments of the present disclosure;

FIG. 44 is a schematic diagram illustrating an exemplary velocity change according to some embodiments of the present disclosure;

FIG. 45 is a flowchart illustrating an exemplary process for controlling a braking device according to some embodiments of the present disclosure;

FIG. 46 is a schematic diagram illustrating an exemplary structure of a control device for an electric mobility apparatus according to some embodiments of the present disclosure;

FIG. 47 is a schematic diagram illustrating an exemplary structure of a control system for an electric mobility apparatus according to some embodiments of the present disclosure; and

FIG. 48 is a schematic diagram illustrating an exemplary structure of an electric mobility apparatus according to some embodiments of the present disclosure.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, the operations may be executed in reverse order or simultaneously. Additionally, one or more other operations may be added to these processes, or one or more operations may be removed from these processes.

An electric mobility apparatus is an apparatus that is capable of moving using electricity as a power source. For example, the electric mobility apparatus may include a motorized wheelchair, a motorized stroller, a mobility scooter, or the like. As another example, the electric mobility apparatus may include a motorized two-wheeled vehicle, a motorized three-wheeled vehicle, a motorized multi-wheeled vehicle, a motorized track vehicle, a motorized boat, or the like.

Some embodiments of the present disclosure provide an electric mobility apparatus and a method and a control system for the electric mobility apparatus. The electric mobility apparatus has a reliable structure that is convenient fora user to operate and control. In addition, the electric mobility apparatus has a high safety level. In order to facilitate the elaboration of the subject matter of the present disclosure, the electric mobility apparatus in the form of a wheelchair is illustrated below as an example.

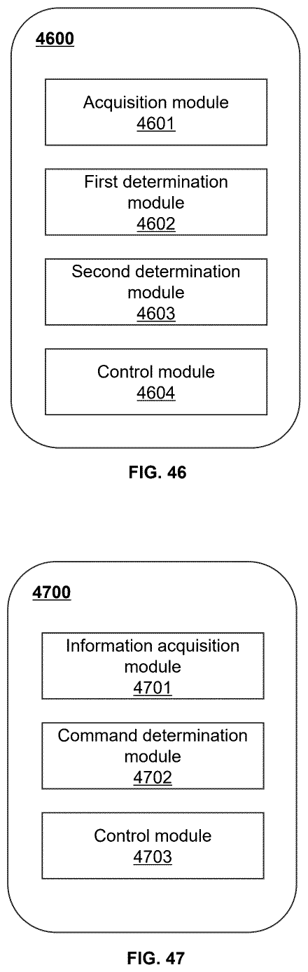

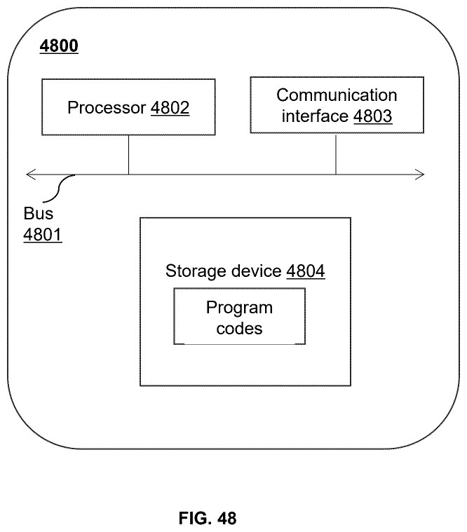

In some embodiments, the electric mobility apparatus includes a processor. In some embodiments, the processor may be configured to process at least one of data or information obtained from various components of the electric mobility apparatus or other components of the control system for the electric mobility apparatus (as shown in FIG. 41 and FIG. 46). For example, input information, control commands, etc., may be transmitted to the processor via a network (e.g, a bus 4801 as shown in FIG. 48) for processing by the processor. In some embodiments, the processor may be a computer, a user console, a single processor, a processor group, or the like. The processor group may be centralized or distributed.

In some embodiments, the processor may be configured to: obtain input information of the electric mobility apparatus in a current operation mode; determine one or more control commands for the electric mobility apparatus based on the input information in the current operation mode; and control the electric mobility apparatus to perform one or more actions based on the one or more control commands. More descriptions of the operations of the processor may be found in the related descriptions below.

In some embodiments, the electric mobility apparatus may further incldue a push device. The push device may be provided with at least one of a force sensor or a torque sensor.

The push device refers to a device for a user to push the electric mobility apparatus. For example, the push device may include one or more pushing handles on the electric mobility apparatus, a gripping structure (e.g., a gripping groove), or the like. The force sensor refers to a sensor for detecting a force. For example, the force sensor may include a piezoresistive force sensor, a strain force sensor, or the like. The torque sensor refers to a sensor for detecting a torque. For example, the torque sensor may include a strain gauge torque sensor, a phase difference torque speed sensor, or the like. The force sensor or the torque sensor is capable of converting the force or torque into an electrical signal or other forms of signals and transmitting the electrical signal or other forms of signals to the processor.

In some embodiments, the electric mobility apparatus further includes an operation device. The operation device may be configured to receive operation information.

The operation device refers to a device used by the user to perform an operation. For example, the operation device may include an operating lever, a button, an operating panel, or the like. The operating information is information related to user operation. For example, the operation information may include control commands entered by the user.

More descriptions of the processor, the operation mode, the control commands, the push device, etc., may be found in the related descriptions below.

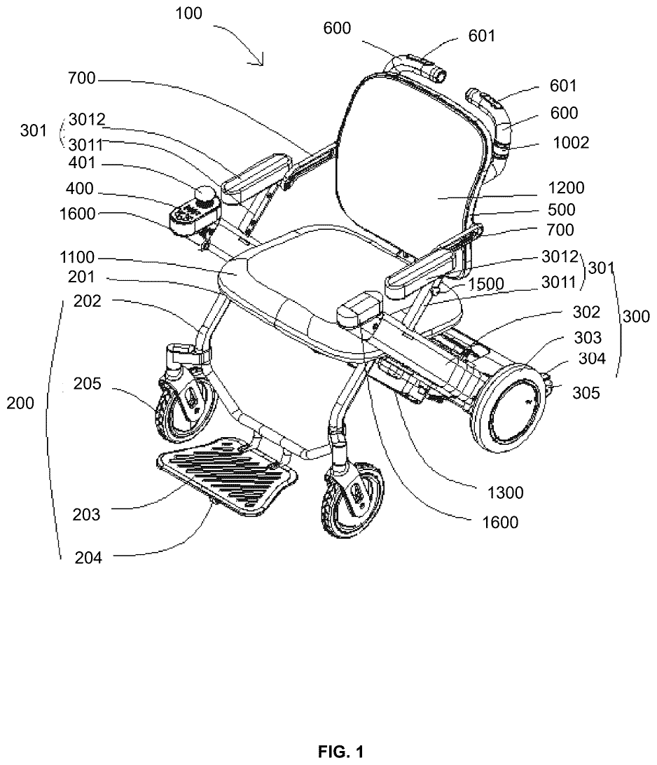

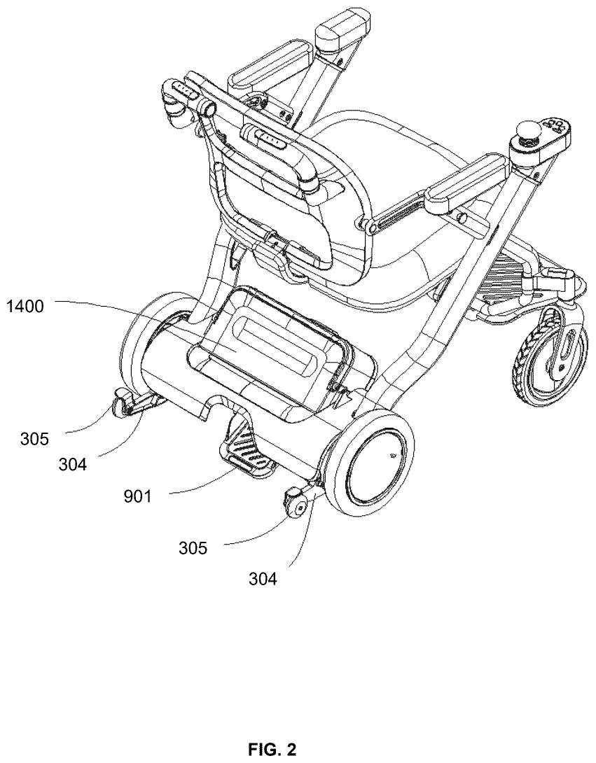

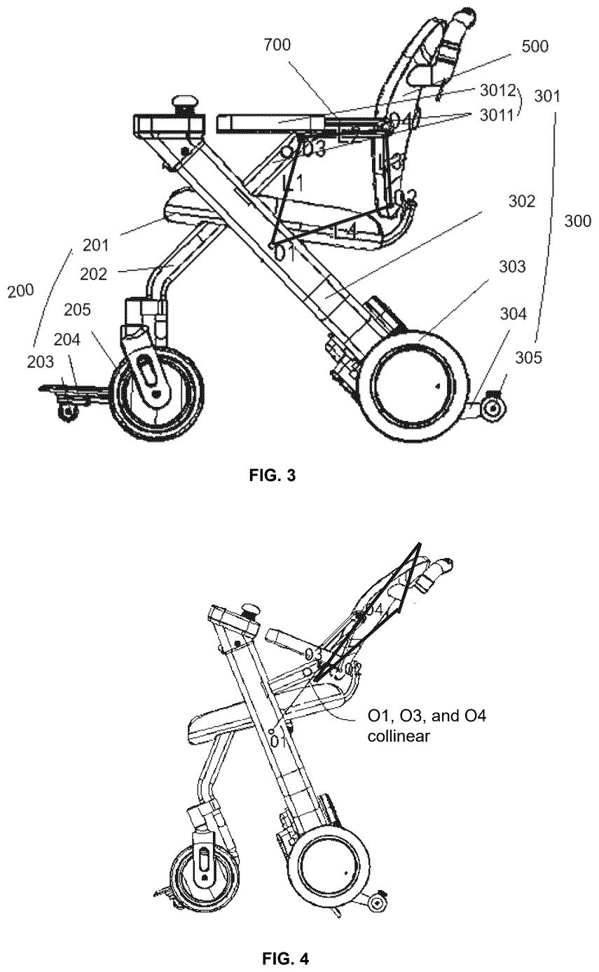

FIG. 1 is a schematic diagram illustrating a structure of an electric mobility apparatus in an unfolded state according to some embodiments of the present disclosure. FIG. 2 is a schematic diagram illustrating a structure of an electric mobility apparatus in an unfolded state observed from another view according to some embodiments of the present disclosure. FIG. 3 is a left view illustrating an electric mobility apparatus in an unfolded state according to some embodiments of the present disclosure.

In some embodiments, an electric mobility device 100 includes a front wheel frame assembly 200, a rear wheel frame assembly 300, a backrest bracket 500, and a connecting member 700, as shown in FIG. 1.

The front wheel frame assembly 200 refers to a component located on a front side. The rear wheel frame assembly 300 refers to a component located on a rear side. The front side refers to a side near a forward direction of the electric mobility apparatus, and the rear side refers to a side away from the forward direction of the electric mobility apparatus. The backrest bracket 500 is a component that supports a backrest. The backrest is a component that provides leaning for a user when the user is riding the electric mobility apparatus. The connecting member 700 is a member for connecting.

In some embodiments, the front wheel frame assembly 200 includes a seat surface bracket 201. The seat surface bracket 201 includes at least one unfolded state. In the at least one unfolded state, the seat surface bracket may be ridden by the user.

In some embodiments, the rear wheel frame assembly 300 is connected to the front wheel frame assembly 200; the backrest bracket 500 is connected to the seat surface bracket 201; and the connecting member 700 is connected to the rear wheel frame assembly 300 and the backrest bracket 500.

In some embodiments, the foregoing connections may include a fixed connection, a rotatable connection, or the like. The fixed connection may include a variety of feasible forms, such as a screw connection, a welded fixing, or the like. When a portion of the foregoing connections are fixed connections, the electric mobility apparatus may be a non-foldable apparatus (i.e., the electric mobility apparatus only has an unfolded state). When the electric mobility apparatus is used for a long term or there is no need for folding, e.g., when the electric mobility apparatus is a communal power wheelchair in a hospital, a non-foldable structure of the electric mobility apparatus is more robust and safer and more reliable to use. The rotatable connection may include a variety of feasible forms, such as a pin connection, a hinge connection, or the like.

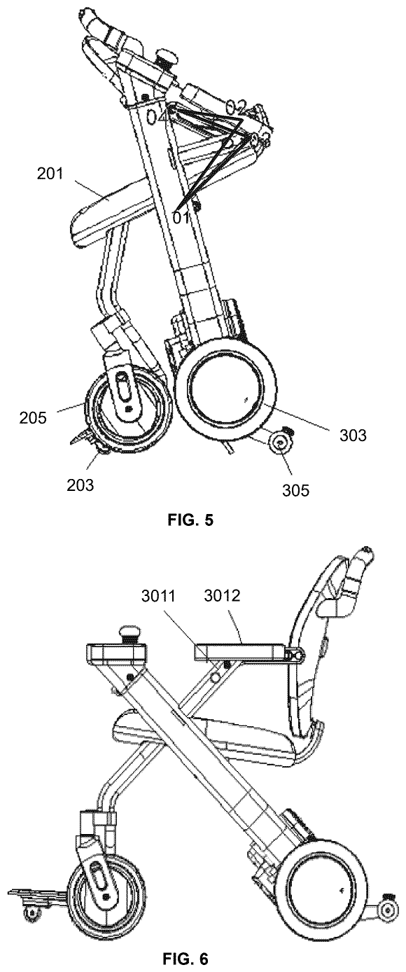

In some embodiments, when the foregoing connection is the rotatable connection, the electric mobility apparatus may be a collapsible device, i.e., the electric mobility apparatus has an unfolded state and a folded state (e.g., FIG. 1 shows the unfolded state and FIG. 5 shows the folded state).

In some embodiments, as shown in FIG. 3, the rear wheel frame assembly 300 is connected to the front wheel frame assembly 200 through at least one first rotational connection O1; the backrest bracket 500 is connected to the seat surface bracket 201 through at least one second rotational connection O2; the connecting member 700 is connected to the rear wheel frame assembly 300 through at least one third rotation connection O3 and connected to the backrest bracket 500 through at least one fourth rotation connection O4. The first rotation connection O1, the second rotation connection O2, the third rotation connection O3, and the fourth rotation connection O4 are not located on a same straight line. Through the above configuration, it is possible for the first rotation connection O1, the second rotation connection O2, the third rotation connection O3, and the fourth rotation connection O4 to be distributed in a quadrilateral shape, so as to make the front wheel frame assembly 200, the rear wheel frame assembly 300, the backrest bracket 500, and the connecting member 700 to form a four-linkage mechanism, which facilitates the user in folding the electric mobility apparatus 100.

In some embodiments, in the unfolded state, the first rotational connection point O1 and the third rotational connection point O3 are located in front of the second rotational connection point O2 and the fourth rotational connection point O4, and the third rotational connection point O3 and the fourth rotation connection point O4 are located above the first rotational connection point O1 and the second rotational connection point O2. A sum of a distance L1 between the first rotational connection point O1 and the third rotational connection point O3 and a distance L2 between the third rotational connection point O3 and the fourth rotational connection point O4 may be less than a sum of a distance L3 between the second rotational connection point O2 and the fourth rotational connection point O4 and a distance L4 between the first rotational connection point O1 and the second rotational connection point O2. In other words, the sum of L1 and L2 may be less than the sum of L3 and L4. More descriptions of ths embodiment may be found in related descriptions below.

In some embodiments, the front wheel frame assembly 200 further includes a front frame and a front wheel, the front frame being rigidly connected to the seat surface bracket and the front wheel being connected to the front frame. A rigid connection indicates that relative positions of connected parts remain unchanged. The rigid connection may include a variety of feasible forms, such as a screw connection, a plug-in connection, or the like.

In some embodiments, the rear wheel frame assembly 300 includes a rear frame, a rear wheel, and an armrest assembly, the rear frame being rotatably connected to the front frame at the first rotational connection point, and the rear wheel being connected to the rear frame. The connection between the front wheel and the front frame and the connection between the rear wheel and the rear frame may include a variety of feasible forms, such as, a pin connection, a snap connection, or the like.

In some embodiments, the electric mobility apparatus further includes an operation device, the armrest assembly is connected to the rear frame, and the operation device is disposed on the armrest assembly. More descriptions of the operation device may be found in related descriptions above.

In some embodiments, the electric mobility apparatus further includes a push device. The push device may include one or more pushing handles, and at least one of the one or more pushing handles may be provided with a force sensor or a torque sensor. For example, the push device may include one push handle, the push handle being provided with a force sensor or a torque sensor, or the push handle being provided with a force sensor and a torque sensor. As another example, the push device may include two pushing handles, wherein one of the two pushing handles may be provided with a force sensor or a torque sensor, or one of the two pushing handles may be provided with a force sensor and a torque sensor. Alternatively, each of the two push handles may be provided with a force sensor or a torque sensor, or each of the two push handles may be provided with a force sensor and a torque sensor.

In some embodiments, at least a portion of the one or more pushing handles may be rotatably connected to a rear side of the backrest bracket (e.g., as shown in FIGS. 17 to 19).

In some embodiments, the electric mobility apparatus further includes a plurality of positioning assemblies. The plurality of positioning assemblies may provide a positioning force for the at least a portion of the one or more pushing handles when the at least a portion of the one or more pushing handles rotates to one or more preset rotation positions. The preset rotation positions may be any feasible positions, e.g., the preset rotation positions may include positions illustrated in FIGS. 17-19. The positioning force is a force used for positioning. For example, when the pushing handle rotates to the preset rotation position, the positioning force may cause the pushing handle to be held in the preset rotation position. As another example, when the pushing handle rotates to the preset rotation position, the positioning force may be a force of the positioning assembly that prevents the pushing handle from leaving the preset rotation position. A magnitude of the positioning force may be set as long as it enables an operator to sense that the pushing handle is in the preset rotation position. It may be understood that in some embodiments, the pushing handle may continue to rotate when a force rotating the pushing handle exceeds the positioning force.

In some embodiments, the seat surface bracket is provided with a load sensor. The load sensor refers to a sensor for detecting a weight of a load. For example, the load sensor may include a photoelectric load sensor, a yardstick sensor, or the like. The load sensor may obtain a weight borne by the seat surface bracket, which may characterize whether or not there is a person or object riding on the seat of the electric mobility apparatus 100.

In some embodiments, at least one of the front wheel frame assembly or the rear wheel frame assembly is provided with a vibration sensor. The vibration sensor refers to a sensor for detecting vibration. For example, the vibration sensor may include an inductive vibration sensor, a capacitive vibration sensor, or the like. In some embodiments, the vibration sensor may be configured to collect vibration information of the electric mobility apparatus during movement, and the processor may be further configured to determine road condition information corresponding to the electric mobility apparatus when the electric mobility apparatus is moving based on the vibration information.

In some embodiments, the electric mobility apparatus may further include an optical detection component. The optical detection component may be configured to collect environmental information corresponding to the electric mobility apparatus when the electric mobility apparatus is moving, and the processor may be further configured to determine road condition information corresponding to the electric mobility apparatus based on the environmental information. The optical detection component is a component that utilizes optics for detection. For example, the optical detection component may include an optical sensor, a camera, a video camera, or the like.

More descriptions of the embodiment may be found in related descriptions below.

The electric mobility apparatus is usually designed to be foldable for easy carrying, stowing, transporting, and storing. After folding, the overall length or volume of the electric mobility apparatus may be reduced. At present, when folding such electric mobility apparatus, there are technical problems such as a complex folding structure, a low folding operation position, a relatively large force required for the folding operation, and multiple folding steps.

Some embodiments of the present disclosure provide an electric mobility apparatus, which may be folded. The folding structure is simple, with relatively few folding steps and labor-saving folding operations. Users may flexibly choose the folding operation position according to their needs. For example, individuals with back discomfort may manually operate the backrest bracket or use feet to operate the front or rear wheel frame assembly for folding, thereby eliminating the need to bend over. In some embodiments, as shown in FIG. 1, the electric mobility apparatus includes at least the front wheel frame assembly 200, the rear wheel frame assembly 300, the backrest bracket 500, and the connecting member 700.

The front wheel frame assembly 200 includes the seat surface bracket 201. In the unfolded state, the seat surface bracket 201 may be ridden by a user.

The rear wheel frame assembly 300 is rotationally connected to the front wheel frame assembly 200 through a first rotational connection point O1 (in conjunction with FIG. 3).

The backrest bracket 500 is rotationally connected to the seat surface bracket 201 through a second rotational connection point O2 (in conjunction with FIG. 3) so that the backrest bracket 500 may swing back and forth relative to the seat surface bracket 201. The backrest bracket 500 is configured for the user to lean on in the unfolded state.

The connecting member 700 is rotationally connected to the rear wheel frame assembly 300 through a third rotational connection point O3 (in conjunction with FIG. 3). The connecting member 700 is also rotationally connected to the backrest bracket 500 through a fourth rotational connection point O4 (in conjunction with FIG. 3).

As shown in FIG. 3, in the unfolded state, the first rotational connection point O1, the second rotational connection point O2, the third rotational connection point O3, and the fourth rotational connection point O4 are distributed in a quadrilateral shape so that the front wheel frame assembly 200, the rear wheel frame assembly 300, the backrest bracket 500, and the connecting member 700 are constructed to form a four-linkage mechanism.

The folding of the above electric mobility apparatus may be realized by rotating any one of the front wheel frame assembly 200, the rear wheel frame assembly 300, the backrest bracket 500, and the connecting member 700, thus satisfying operation needs and operation habits of different users. For example, for a user with back discomfort, the backrest bracket 500 may be manually operated to fold or the front wheel frame assembly 200 or the rear wheel frame assembly 300 may be operated by foot to fold without bending.

As shown in FIG. 3, the front wheel frame assembly 200 further includes a front frame 202 and front wheels 205. The front frame 202 is rigidly connected to the seat surface bracket 201. The front wheels 205 are connected to the front frame 202, and the front wheels 205 may rotate relative to the front frame 202. For example, the front wheels 205 are connected to the front frame 202 via bearings, and the front wheels 205 rotate via the bearings. The front wheels 205 are configured to contact a ground in the unfolded state. The rear wheel frame assembly 300 further includes a rear frame 302 and rear wheels 303. The rear frame 302 is rotatably connected to the front frame 202 through the first rotational connection O1 described above. The rear wheels 303 are connected to the rear frame 302, and may rotate relative to the rear frame 302. The rear wheels 303 are configured to contact the ground in the unfolded state. The rotation of the front wheels 205 and the rear wheels 303 with respect to the frame allows the electric mobility apparatus to move forward or backward.

In some embodiments, as shown in FIG. 3, in the unfolded state, the first rotational connection point O1 and the third rotational connection point O3 are located in front of the second rotational connection point O2 and the fourth rotational connection point O4. The third rotation connection O3 and the fourth rotation connection O4 are located above the first rotation connection O1 and the second rotation connection O2. The distance between the first rotation connection O1 and the third rotation connection O3 is L1. The distance between the third rotation connection O3 and the fourth rotation connection O4 is L2. The distance between the second rotation connection O2 and the fourth rotation connection O4 is L3. The distance between the first rotation connection O1 and the second rotation connection O2 is L4. A sum of L1 and L2 is less than a sum of L3 and L4.

FIG. 4 is a left view illustrating an electric mobility apparatus during a folding process according to some embodiments of the present disclosure. FIG. 5 is a left view illustrating an electric mobility apparatus in a folded state according to some embodiments of the present disclosure.

In some embodiments of the present disclosure, during the folding process of the electric mobility apparatus, the backrest bracket 500 first rotates backward until the first rotational connection point O1, the third rotational connection point O3, and the fourth rotational connection point O4 are collinear (as shown in FIG. 4), then changes to rotate forward to approach the seat surface bracket 201. Comparing FIGS. 3 and 4, during the backward rotation of the backrest bracket 500, lower ends of the front wheel frame assembly 200 and the rear wheel frame assembly 300 move closer to each other, the front wheels 205 and the rear wheels 303 move closer to each other, and a rear side of the seat surface bracket 201 moves upward while a front side of the seat surface bracket 201 moves downward. Comparing FIGS. 4 and 5, during the forward rotation of the backrest bracket 500, the lower ends of the front wheel frame assembly 200 and the rear wheel frame assembly 300 move even closer to each other, the front wheels 205 and the rear wheels 303 move even closer, and the rear side of the seat surface bracket 201 moves further upward while the front side moves further downward, which results in a very small front-to-back dimension when the electric mobility apparatus is fully folded, making it very easy to be stored. Additionally, during the folding process, the backrest bracket 500 first rotates backward and then forward, requiring less space compared to continuous backward rotation, thereby allowing the electric mobility apparatus to be folded in narrow spaces.

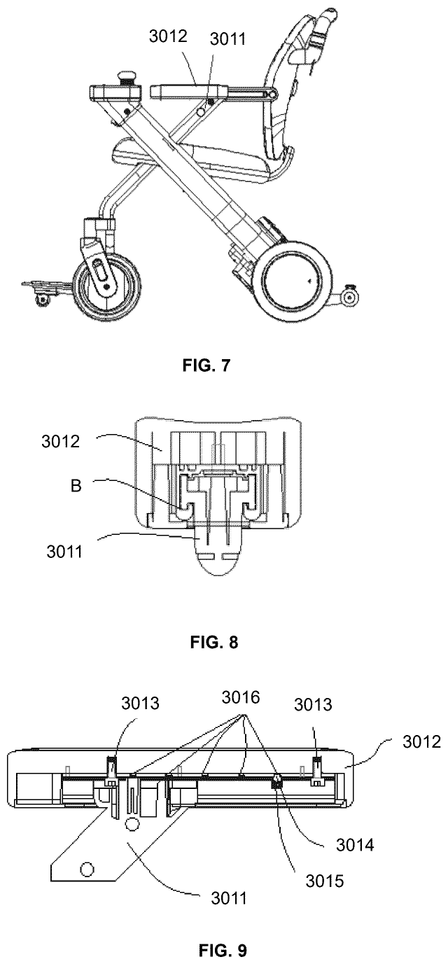

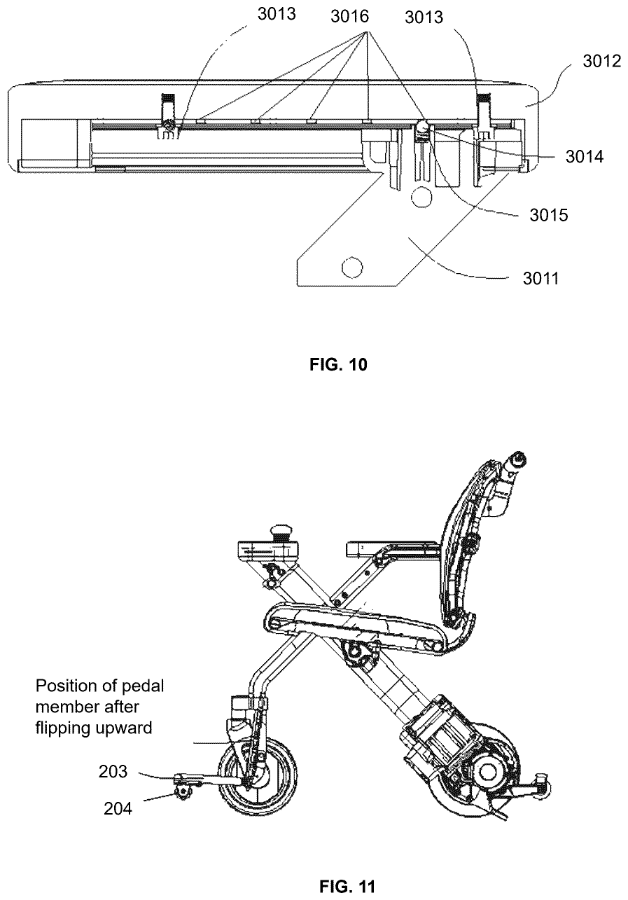

FIG. 6 is a left view illustrating an armrest of an electric mobility apparatus sliding backward to a position according to some embodiments of the present disclosure. FIG. 7 is a left view illustrating an armrest of an electric mobility apparatus sliding forward to a position according to some embodiments of the present disclosure. FIG. 8 is a schematic diagram illustrating a sliding connection between an armrest and an armrest bracket of an electric mobility apparatus via a slide groove according to some embodiments of the present disclosure. FIG. 9 is an interior view illustrating an armrest of an electric mobility apparatus sliding backward along an armrest bracket to a limit position according to some embodiments of the present disclosure. FIG. 10 is an interior view illustrating an armrest of an electric mobility apparatus sliding forward along an armrest bracket to a limit position according to some embodiments of the present disclosure.

In some embodiments, the rear wheel frame assembly 300 may also include an armrest assembly 301. As shown in FIG. 6 and FIG. 7, the armrest assembly 301 includes an armrest bracket 3011 and an armrest 3012. The armrest bracket 3011 is rigidly connected to the rear frame 302. The armrest 3012 is slidingly connected to the armrest bracket 3011 and may slide back and forth relative to the armrest bracket 3011. As shown in FIG. 8, the armrest 3012 may be slidingly connected to the armrest bracket 3011 through a slide groove (indicated by B in FIG. 8). As shown in FIG. 9 and FIG. 10, the armrest 3012 is connected to a stop member 3013 at a front end and a rear end of the armrest 3012 for limiting a forward sliding limit position and a backward sliding limit position of the armrest 3012, respectively. As shown in FIG. 9, when the armrest 3012 slides backward to a backward limit position, the stop member 3013 on the front end resists against the armrest bracket 3011, so that the armrest 3012 may not continue to slide backward. As shown in FIG. 10, when the armrest 3012 slides forward to a forward limit position, the stop member 3013 on the rear end resists against the armrest bracket 3011, so that the armrest 3012 may not continue to slide forward.

In some embodiments, the armrest bracket 3011 is rotationally connected to the rear frame 302. For example, when a cushion 1100 is provided in close proximity to the armrest 3012, the rotational connection of the armrest bracket 3011 to the rear frame 302 allows the armrest assembly 301 to be foldable.

In some embodiments, the electric mobility apparatus may also be provided without the armrest 3012, for example, when the electric mobility apparatus is a motorized stroller.

In some embodiments, one of the armrest 3012 and the armrest bracket 3011 may be provided with a positioning portion, and the other may be provided with a plurality of positioning grooves 3016 spaced apart sequentially in a front-to-back direction, as illustrated in FIG. 9 and FIG. 10. In this way, as the armrest 3012 slides, the positioning portion may align with different positioning grooves 3016. When the armrest 3012 slides to a position where the positioning portion is aligned with one positioning groove 3016, the positioning portion may automatically enter the aligned positioning groove 3016, thereby stopping the armrest 3012 in the position. In this way, the armrest 3012 may stop at a plurality of different positions, thereby satisfying different user needs.

In some embodiments, the positioning portion may include a ball 3014 and a ball spring 3015, with one end of the ball spring 3015 being mounted in a mounting groove on the armrest bracket 3011 or the armrest 3012, and the ball 3014 being disposed on the ball spring 3015. When the armrest 3012 slides to a position where the positioning portion aligns with one of the positioning grooves 3016, the ball 3014 automatically enters the positioning groove 3016 under an action of an elastic force of the ball spring 3015, thereby stopping the armrest 3012 at the position. If it is desired to slide the armrest 3012 again, it is necessary to apply a certain amount of force so that the ball spring 3015 is disengaged from the positioning groove 3016, thereby releasing the armrest 3012 from positioning. The above described positioning structure makes it easier to un-position the armrest 3012 and provides the armrest 3012 with a smooth sliding feel. The structure of the positioning portion is not limited to the above described structure. For example, the positioning portion may also be a standard positioning pin that relies on gravity to fall into the aligned positioning groove.

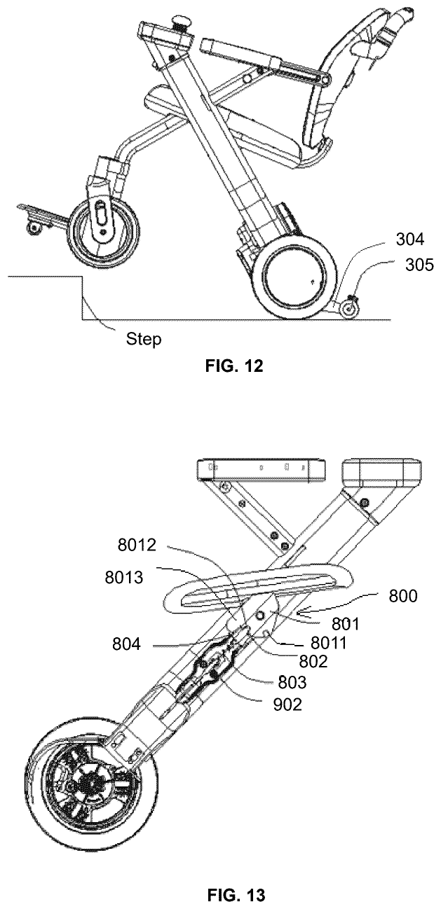

FIG. 11 is a schematic diagram illustrating two positions of a pedal member of an electric mobility apparatus according to some embodiments of the present disclosure. FIG. 12 is a schematic diagram illustrating a manner of using an electric mobility apparatus when the electric mobility apparatus passes through a step according to some embodiments of the present disclosure.

In some embodiments, as shown in FIG. 11, the front wheel frame assembly 200 may also include a pedal member 203 used for foot support of a user in the unfolded state. The pedal member 203 may be rotationally connected to the front frame 202 and may flip up and down with respect to the front frame 202. The pedal member 203 may flip downward to a nearly horizontal position or flip upward to a nearly vertical position, such as an angle of 95° with a horizontal plane. Flipping the pedal member 203 upward makes it easier for the user to get on and off the electric mobility apparatus. The pedal member 203 may also be fixedly connected to the front frame 202, in which case the pedal component 203 may not flip up or down relative to the front frame 202.

In some embodiments, as shown in FIG. 11, the front wheel frame assembly 200 may also include a front support wheel 204, the front support wheel 204 being connected to the pedal member 203. For example, the front support wheel 204 may be connected to the pedal member 203 near a front end of the pedal member 203. As shown in FIG. 3, in the unfolded state, the front support wheel 204 is suspended from the ground, and a suspension distance may be flexibly designed according to needs, for example, 4 cm. As shown in FIG. 5, in the folded state, the front support wheel 204 is in contact with the ground and supports the electric mobility apparatus 100 to move, and the front wheels 205 are suspended from the ground. With this design, the electric mobility apparatus 100 may move with little effort by the rolling of the front support wheel 204 after folding.

In some embodiments, as shown in FIG. 12, the rear wheel frame assembly 300 may also include a rear anti-tip member 304. In the unfolded state, a rear end of the rear anti-tip member 304 is further back than the rear wheels 303, and the rear anti-tip member 304 is suspended from the ground. There are various ways in which the rear anti-tip member 304 may be realized to be suspended from the ground. For example, the front end of the rear anti-tip member 304 may be fixed to axles of the rear wheels 303. As another example, a lower portion of the rear frame 302 may be provided with a horizontal shaft substantially parallel to the axles of the rear wheels 303, the horizontal shaft being suspended from the ground, and a front end of the rear anti-tip member 304 may be fixed in a middle region of the horizontal shaft. According to the rear anti-tipping member 304, when passing through an obstacle (e.g., the step shown in FIG. 12), a helper may step on the rear anti-tipping member 304 to cause a front portion of the electric mobility apparatus to be cocked upwardly, thereby enabling the electric mobility apparatus to pass through the obstacle conveniently and with little effort. Additionally, the rear anti-tipping member 304 prevents the electric mobility apparatus from tipping backwards.

In some embodiments, as shown in FIG. 12, the rear wheel frame assembly 300 may further include a rear support wheel 305, which may be connected to the rear anti-tipping member 304. In the unfolded state, the rear support wheel 305 is suspended from the ground, as shown in FIG. 3. As shown in FIG. 5, in the folded state, the rear support wheel 305 is in contact with the ground and support the electric mobility apparatus 100 to move, and the rear wheels 303 are suspended from the ground. With this design, the electric mobility apparatus 100 may move with little effort by the rolling of the rear support wheel 305 after folding. Exemplarily, the rear support wheel 305 may be connected to the rear end of the rear anti-tipping member 304, so that when passing through an obstacle, the helper may step on the rear anti-tipping member 304 to lift the front portion of the electric mobility apparatus, allowing the rear support wheel 305 to contact with the ground. By relying on the rolling of the rear support wheel 305, the electric mobility apparatus may pass over the obstacle with less effort.

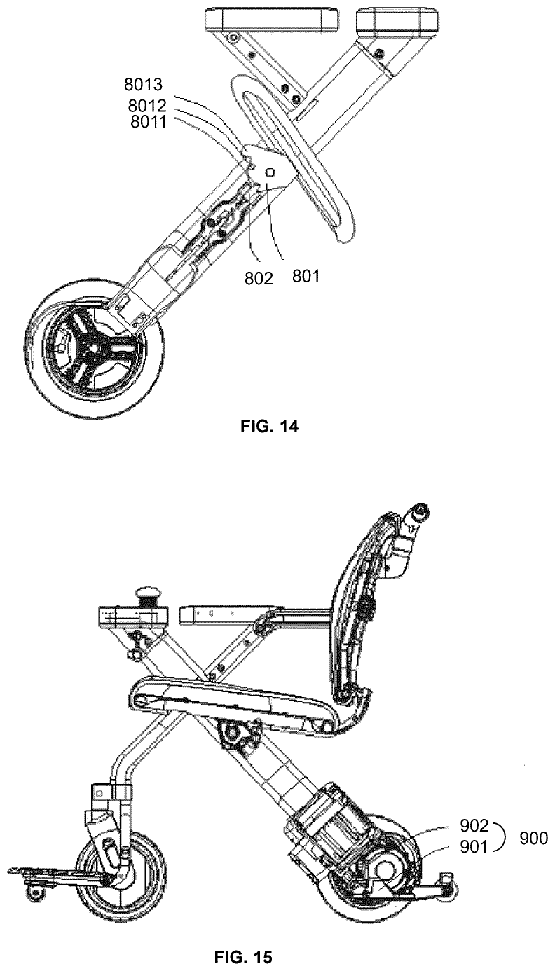

FIG. 13 is a schematic diagram illustrating positions of a first limiting member and a limiting pin of an electric mobility apparatus in an unfolded state according to some embodiments of the present disclosure. FIG. 14 is a schematic diagram illustrating positions of a first limiting member and a limiting pin of an electric mobility apparatus in a folded state according to some embodiments of the present disclosure.

In some embodiments, the electric mobility apparatus 100 further includes a limiting mechanism 800 and a release mechanism 900. The limiting mechanism 800 may be configured to restrict relative positions of the front wheel frame assembly 200 and the rear wheel frame assembly 300 in the unfolded state and in the folded state, and the release mechanism 900 may be configured to release the limiting mechanism 800 from restricting the positions of the front wheel frame assembly 200 and the rear wheel frame assembly 300.

In some embodiments, the limiting mechanism 800 includes a first limiting member 801, a limiting pin 802, and a first elastic reset member 803, as shown in FIG. 13 or FIG. 14. One of the first limiting member 801 or the limiting pin 802 may be connected to the front wheel frame assembly 200 and the other may be connected to the rear wheel frame assembly 300. The positions of the first limiting member 801 and the limiting pin 802 may be reversed, and the limiting pin 802 is connected to the rear wheel frame assembly 300. The first limiting member 801 is provided with a folding limiting groove 8011 and an unfolding limiting groove 8012 adapted to the limiting pin 802. The first limiting member 801 may be a plate-like structure, and the folding limiting groove 8011 and the unfolding limiting groove 8012 may be provided at an edge of the plate-like structure, so that the edge of the plate-like structure is in the form of a serrated shape.

As shown in FIG. 13, in the unfolded state, the unfolding limiting groove 8012 faces the limiting pin 802, and the limiting pin 802 is inserted into the unfolding limiting groove 8012. As shown in FIG. 14, in the folded state, the folding limiting groove 8011 faces the limiting pin 802, and the limiting pin 802 is inserted into the folding limiting groove 8011. The limiting pin 802 and the first limiting member 801 may move away from each other under an external force to enable the limiting pin 802 to be dislodged from the folding limiting groove 8011 or the unfolding limiting groove 8012. The first elastic reset member 803 is disposed at an end of the limiting pin 802 that is away from the first limiting member 801, and the first elastic reset member 803 may be a spring, a resilient rubber pad, etc. The limiting pin 802 and the first limiting member 801 may be relatively close to each other under an action of a resilient force of the first elastic reset member 803, so as to reset the limiting pin 802 to be inserted into the folding limiting groove 8011 or the unfolding limiting groove 8012.

As shown in FIG. 13, the first limiting member 801 is further provided with a stopping portion 8013. In addition, the limiting mechanism 800 is provided with a second limiting member 804, the limiting pin 802 is inserted in a pin groove on the second limiting member 804, and connection to the rear wheel frame assembly 300 is realized through the second limiting member 804. In the unfolded state, the stopping portion 8013 and the second limiting member 804 stop each other, thereby further serving as a limiting function.

The limiting mechanism of the above-described structure is simple in structure, has a high reliability of limiting, and is connected with the front wheel frame assembly 200 and the rear wheel frame assembly 300 without fragmented parts. Of course, the structure of the limiting mechanism is not limited, theoretically, as long as it is capable of limiting the relative positions of the front wheel frame assembly 200 and the rear wheel frame assembly 300. For example, each of the front wheel frame assembly 200 and the rear wheel frame assembly 300 may be provided with two limiting holes and limiting pins adapted to the two limiting holes. In the folded state, one limiting hole in the front wheel frame assembly 200 is aligned with one limiting hole in the rear wheel frame assembly 300, a limiting pin is inserted into the aligned limiting holes, thereby restricting the front wheel frame assembly 200 and the rear wheel frame assembly 300 to the folded state. In the unfolded state, another limiting hole in the front wheel frame assembly 200 and another limiting hole in the rear wheel frame assembly 300 are aligned, and the limiting pin is inserted into the aligned limiting holes, thereby restricting the front wheel frame assembly 200 and rear wheel frame assembly 300 to the unfolded state.

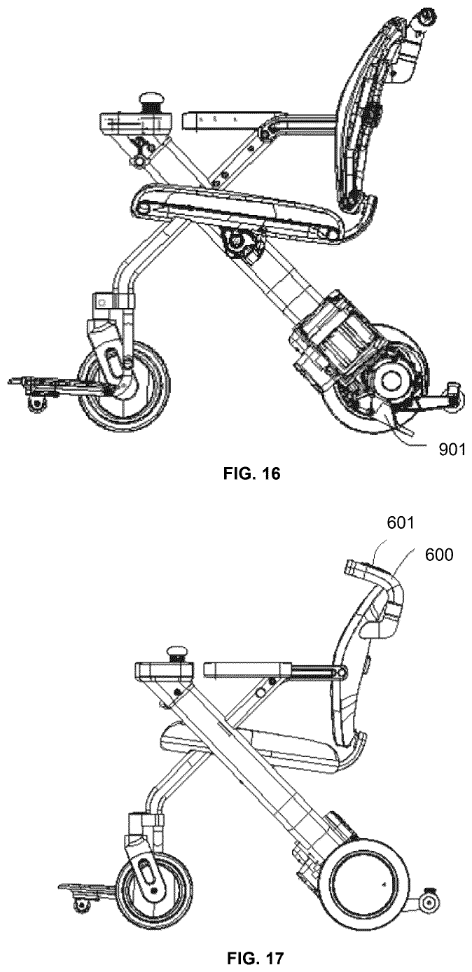

FIG. 15 is a schematic diagram illustrating a position of a releasing pedal when an electric mobility apparatus is in a limiting state according to some embodiments of the present disclosure. FIG. 16 is a schematic diagram illustrating a position of a releasing pedal when an electric mobility apparatus is in a released state according to some embodiments of the present disclosure.

In some embodiments, the releasing mechanism 900 includes a releasing pedal 901 and a releasing drive member 902, as shown in FIG. 15. The releasing pedal 901 is rotatably connected to the front wheel frame assembly 200 or the rear wheel frame assembly 300. If the limiting pin 802 is connected to the front wheel frame assembly 200, the releasing pedal 901 is connected to the front wheel frame assembly 200; if the limiting pin 802 is connected to the rear wheel frame assembly 300, the releasing pedal 901 is connected to the rear wheel frame assembly 300. Connecting the releasing pedal 901 to the rear wheel frame assembly 300 allows for easier operation. The releasing pedal 901 is connected to the limiting pin 802 via the releasing drive member 902 so that it is possible to rotate the releasing pedal 901 to disengage the limiting pin 802 from the folding limiting groove 8011 or the unfolding limiting groove 8012. For example, the releasing drive member 902 may be a flexible drive member or a rigid drive member. For example, the releasing drive member 902 may be a cord, with one end of the cord connected to an end of the limiting pin 802 near the first elastic reset member 803, and another end of the cord connected to the releasing pedal 901. Exemplarily, as shown in FIG. 15, in the limiting state, the releasing pedal 901 is roughly in a horizontal position. To release the limitation, the releasing pedal 901 is pressed downward and rotates from the roughly horizontal position shown in FIG. 15 to a rear side downward inclined position shown in FIG. 16. The releasing mechanism has a simple structure and is easy to operate. Of course, the structure of the releasing mechanism is not limited to the described structure. Theoretically, the releasing mechanism may be configured as any structures as long as the position limitation of the front wheel frame assembly 200 and the rear wheel frame assembly 300 by the limiting mechanism 800 can be released.

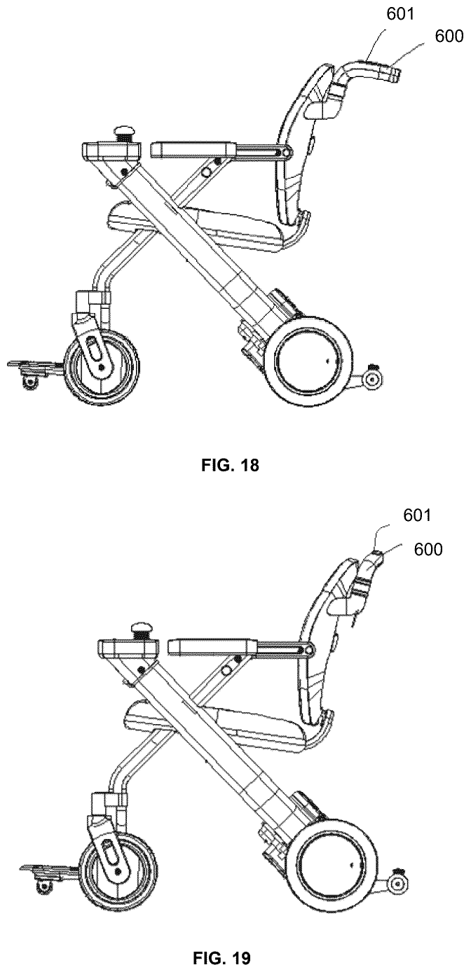

FIG. 17 is a schematic diagram illustrating a forward-facing position of handles of an electric mobility apparatus according to some embodiments of the present disclosure. FIG. 18 is a schematic diagram illustrating a rearward-facing position of handles of an electric mobility apparatus according to some embodiments of the present disclosure. FIG. 19 is a schematic diagram illustrating an inward-facing position of handles of an electric mobility apparatus according to some embodiments of the present disclosure.

In some embodiments, the backrest bracket 500 may be rotatably connected to one or more handles 600. The handles are also referred to as pushing handles, and the one or more handles 600 may rotate horizontally relative to the backrest bracket 500. In some embodiments, the electric mobility apparatus includes a plurality of positioning assemblies. In some embodiments, the positioning assembly may be a locking and unlocking mechanism 1000. The locking and unlocking mechanism 1000 may be configured to lock the one or more handles 600 in a forward-facing position (the position shown in FIG. 17) or a rearward-facing position (the position shown in FIG. 18) or an inward-facing position (the position shown in FIG. 19). The locking and unlocking mechanism 1000 may also unlocking the one or more handles 600 from the locked positions. The forward-facing position shown in FIG. 17, the rearward-facing position shown in FIG. 18, and the inward-facing position shown in FIG. 19 may be preset rotational positions of the one or more handles 600, and the locking unlocking mechanism 1000 may provide a positioning force for the one or more handles 600 by locking.

The electric mobility apparatus may include a riding mode and a push mode. When the electric mobility apparatus is in the riding mode, the one or more handles 600 are rotated to the inward-facing position to reduce riding resistance. The push mode may include an assisted push mode and a rehabilitation assist mode. When the electric mobility apparatus is in the assisted push mode, the one or more handles 600 may be rotated to the rearward-facing position, and an assisted pusher is positioned behind the electric mobility apparatus, holding the one or more handles in his or her hands to push the electric mobility apparatus. When the electric mobility apparatus is in the rehabilitation assist mode, the one or more handles 600 are rotated to the forward-facing position, and a rehabilitator is positioned in front of the electric mobility apparatus, holding the one or more handles in his or her hands to push the electric mobility apparatus.

The assisted push mode is a mode in which a first user (e.g., a rider) rides the electric mobility apparatus and a second user (e.g., a caregiver) pushes the electric mobility apparatus behind the electric mobility apparatus. The rehabilitation assist mode is a mode in which the first user (e.g., the rehabilitator) does not ride the electric mobility apparatus and pushes the electric mobility apparatus alone behind the electric mobility apparatus.

In some embodiments, at least one of the one or more handles 600 is provided with an operation device 601, a force sensor, and a position sensor, as illustrated in FIG. 17-FIG. 20. The operation device 601 may be a button, a knob, a touch key, or the like. The force sensor may be configured to detect a force acted on the handle 600 by a user, and the position sensor may be configured to detect positions of the one or more handles 600. The force sensor and the position sensor may be disposed on a surface of the handle 600 or an interior of the handle 600. In some embodiments, the electric mobility apparatus includes a control module 1300 (referring to FIG. 1) and a driving device (e.g., a motor). The control module 1300 may be communicatively connected to the operation device 601, the force sensor, and the position sensor, and the control module 1300 may be configured to: in response to determining, based on a signal fed back from the position sensor, that the one or more handles 600 is in the forward-facing position or the rearward-facing position, activate a control function of the operation device 601 so that a control command of the user may be fed back to the control module 1300 through the operation device 601. The control module 1300 may be further configured to: shut down a braking function of the motor and control the motor to assist in driving the electric mobility apparatus based on the signal fed back from the force sensor when the control module 1300 receives the control command of the user fed back by the operation device. In response to determining, based on the signal fed back from the position sensor, that the one or more handles 600 is in the inward-facing position, the control module 1300 may turn off the control function of the operation device 601 so that the control command of the user may not be fed back to the control module 1300 through the operation device 601. This design realizes linkage control of different modes of the electric mobility apparatus and different positions of the one or more handles. When the electric mobility apparatus is in the assisted push mode or the rehabilitation assisted mode, the driving device may give an appropriate amount of assistance according to the user's force on the one or more handles 600, so as to make the assisted push mode and the rehabilitation assisted mode have an appropriate speed and be less laborious.

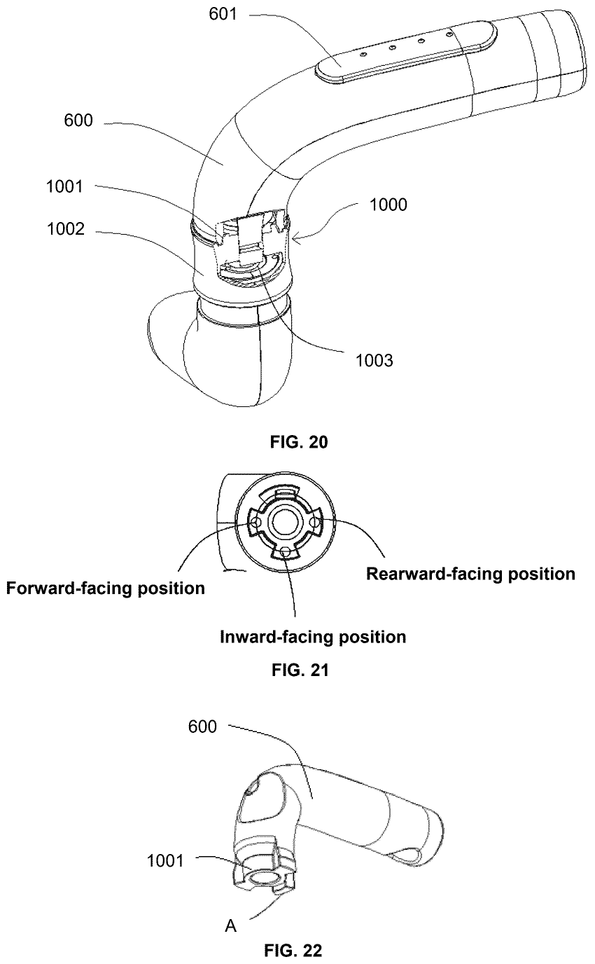

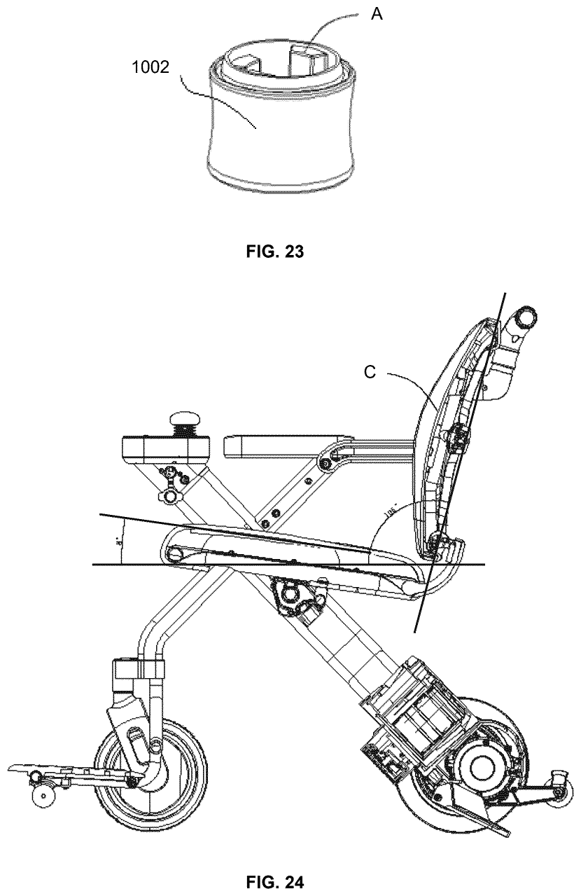

FIG. 20 is a structural diagram illustrating a locking and unlocking mechanism of an electric mobility apparatus according to some embodiments of the present disclosure. FIG. 21 is a schematic diagram illustrating cooperation between a locking tooth sleeve and a locking tooth block of a locking and unlocking mechanism that that restrict a handle of an electric mobility apparatus in a forward-facing position, a rearward-facing position, and an inward-facing positions, respectively, according to some embodiments of the present disclosure. FIG. 22 is a structural diagram illustrating a locking tooth block of a locking and unlocking mechanism of an electric mobility apparatus according to some embodiments of the present disclosure. FIG. 23 is a structural diagram illustrating a locking tooth sleeve of a locking and unlocking mechanism of an electric mobility apparatus according to some embodiments of the present disclosure.

In some embodiments, as shown in FIG. 20, the locking and unlocking mechanism 1000 includes a locking tooth block 1001, a locking tooth sleeve 1002, and a second elastic reset member 1003 disposed in a coaxial arrangement. One of the locking tooth block 1001 or the locking tooth sleeve 1002 may be connected to the handle 600, and another one of the locking tooth block 1001 or the locking tooth sleeve 1002 may be connected to the backrest bracket 500, and positions of the locking tooth block 1001 and the locking tooth sleeve 1002 may be reversed. In the drawings, the locking tooth block 1001 is connected to the handle 600.

As shown in FIG. 21, when the handle 600 is in the forward-facing position, the rearward-facing position, and the inward-facing position, teeth of the locking tooth block 1001 and an intertooth groove of the locking tooth sleeve 1002 are squarely aligned, and the teeth of the locking tooth block 1001 are seated in the intertooth groove of the locking tooth sleeve 1002 When the handle 600 is located in other positions (positions other than the forward-facing position, the rearward-facing position, and the inward-facing position), the teeth of the locking tooth block 1001 are opposite the teeth of the locking tooth sleeve 1002, and the teeth of the locking tooth block 1001 may not be seated in the intertooth groove of the locking tooth sleeve 1002.

The locking tooth block 1001 and the locking tooth sleeve 1002 may be configured to move away from each other under an action of an external force to achieve mutual separation. The locking tooth block 1001 and the locking tooth sleeve 1002 may be configured to move close to each other under an elastic force of the second elastic reset member 1003 for mutual snap-in. In the drawings, the locking tooth sleeve 1002 is located below the locking tooth block 1001, and the locking tooth sleeve 1002 may move up and down. The second elastic reset member 1003 is located below the locking tooth sleeve 1002, and may cause the locking tooth sleeve 1002 to move downward to separate from the locking tooth block 1001. As the locking tooth sleeve 1002 moves downward, the second elastic reset member 1003 is compressed, and after the locking tooth sleeve 1002 is released, the locking tooth sleeve 1002 is reset upwardly under the elastic force of the second elastic reset member 1003.

The locking and unlocking mechanism 1000 is simple in structure, reliable in locking, and convenient in operation. Of course, the structure of the locking and unlocking mechanism 1000 is not limited thereto. The locking and unlocking mechanism may have any structures as long as the handle 600 can be locked in the forward-facing position, the rearward-facing position, and the inward-facing position and unlocked from the above positions.

In some embodiments, as shown in FIG. 22, one tooth of the locking tooth block 1001 near an end (a lower end in the drawing) of the locking tooth sleeve 1002 extends beyond the rest of the teeth of the locking tooth block 1001 to become an extended tooth A. As shown in FIG. 23, one tooth of the locking tooth sleeve 1002 near an end (an upper end in the drawing) of the locking tooth block 1001 extends beyond the rest of the teeth of the locking tooth block 1001 to become an extended tooth A. The extended tooth A of the locking tooth block 1001, after rotating 270° relative to the locking tooth sleeve 1002, moves from a position where it contacts with one side of the extended tooth A of the locking tooth sleeve 1002 to a position where it contacts with the other side of the extended tooth A of the locking tooth sleeve 1002, thereby restricting the handle 600 to rotate within a range of 0°-270° and preventing the handle 600 from exceeding a rotation limit.

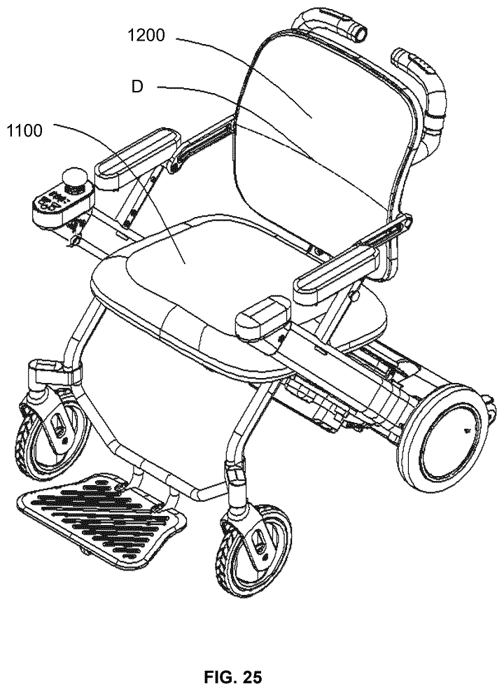

FIG. 24 is a schematic diagram illustrating an angle between a backrest and a cushion of a foldable electric mobility apparatus in an unfolded state according to some embodiments of the present disclosure. FIG. 25 is a schematic diagram illustrating a curved shape of a backrest of a foldable electric mobility apparatus in a horizontal direction according to some embodiments of the present disclosure.

In some embodiments, as shown in FIG. 24, a cushion 1100 is disposed on the seat surface bracket 201, and in the unfolded state, a rear side of the cushion 1100 is tilted downwardly relative to a front side of the cushion 1100, so that there is a preset angle between the cushion 1100 and a horizontal plane. In some embodiments, the preset angle may be set in a range of 7° to 10°, for example, the preset angle may be 8°. A region of the cushion 1100 in contact with the ischium of a rider is a flat surface, and a region of the cushion 1100 in contact with an inner side of the thigh of the rider is a micro-concave curved surface, so as to make the majority of the body weight concentrated at the ischial tuberosity, thereby achieving optimal body pressure distribution and reducing hip fatigue. In some embodiments, a height difference between the cushion 1100 and the pedal member 203 may be in a range of 350 mm to 400 mm. For example, the height difference may be 380 mm.

As shown in FIG. 24, a backrest 1200 is disposed on a front side of the backrest bracket 500, and in the unfolded state, an upper side of the backrest 1200 is tilted backward with respect to a lower side of the backrest 1200, so that there is a preset angle between the backrest 1200 and a vertical plane. In some embodiments, the angle may be in a range of 103° to 107°. For example, the included angle may be 105°, which is a relatively comfortable angle for a sedentary human body.

As shown in FIG. 24, the backrest 1200 has a curved shape (indicated by C in the drawing) that is convex in a center of the backrest 1200 in a vertical direction. As shown in FIG. 25, the backrest 1200 has a curved shape (indicated by D in the drawing) that is concave in the center of the backrest 1200 in a horizontal direction. This double-curve design makes the body of the user in a highly relaxed state when the user sits and leans against the backrest.

As shown in FIG. 1 and FIG. 2, the electric mobility apparatus may also be provided with a battery module 1400 to power the driving device, the control module 1300, or the like. The electric mobility apparatus may also be provided with a hook 1500 to facilitate hooking of carry-on items. The hook 1500 may be disposed at a location convenient for the user to reach, for example, on an outer side of the armrest bracket 3011. The electric mobility apparatus may also be provided with a handrest 1600, the handrest 1600 being provided on a front side of the armrest 3012 for supporting the user's hand. In the drawings, the handrest 1600 is fixed to an upper end of the rear frame 302. The handrest 1600 may be integrated with a center control module 400. The center control module 400 includes a center control handle 401, and the user may control a moving velocity, a moving direction, etc., of the electric mobility apparatus by manipulating the center control handle 401.

Some embodiments of the present disclosure provide a method for folding an electric mobility apparatus.

The method may include: operating any one or more of the front wheel frame assembly 200, the rear wheel frame assembly 300, the backrest bracket 500, and the connecting member 700 to rotate to realize the folding of the electric mobility apparatus.

Exemplarily, in the following scenario: “in the unfolded state, the first rotational connection point O1 and the third rotational connection point O3 are located in front of the second rotational connection point O2 and the fourth rotational connection point O4. The third rotation connection O3 and the fourth rotation connection O4 are located above the first rotation connection O1 and the second rotation connection O2. The distance between the first rotation connection O1 and the third rotation connection O3 is L1. The distance between the third rotation connection O3 and the fourth rotation connection O4 is L2. The distance between the second rotation connection O2 and the fourth rotation connection O4 is L3. The distance between the first rotation connection O1 and the second rotation connection O2 is L4. A sum of L1 and L2 is less than a sum of L3 and L4,” during the folding process, the backrest bracket 500 first rotates backward until the first rotational connection point O1 and the fourth rotational connection point O4 are collinear, then changes to rotate forward to approach the seat surface bracket 201. As the backrest bracket 500 rotates backward, a rear side of the seat surface bracket 201 is moved upward while a front side of the seat surface bracket 201 is moved downward, and a lower end of the front wheel frame assembly 200 and a lower end of the rear wheel frame assembly 300 are closer to each other. As the backrest bracket 500 rotates forward, the rear side of the seat surface bracket 201 is further moved upward, while the front side of the seat surface bracket 201 is further moved downward, and the lower end of the front wheel frame assembly 200 and the lower end of the rear wheel frame assembly 300 are even closer to each other.

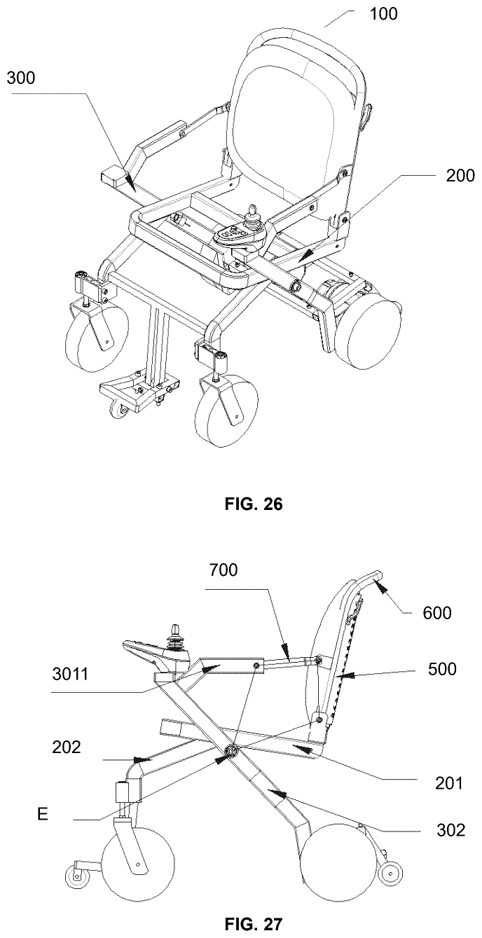

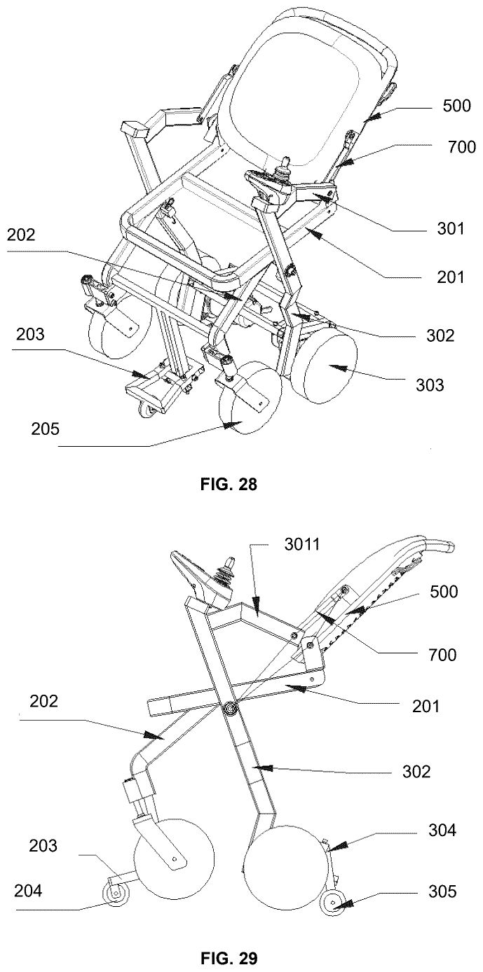

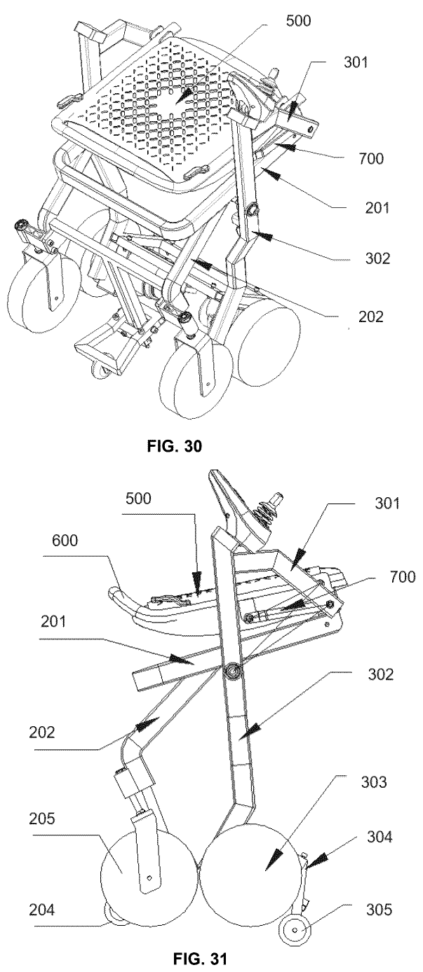

FIG. 26 is a schematic diagram illustrating a structure of a foldable and portable electric mobility apparatus in an unfolded state according to some embodiments of the present disclosure. FIG. 27 is a left view illustrating a foldable and portable electric mobility apparatus in an unfolded state according to some embodiments of the present disclosure. FIG. 28 is a schematic diagram illustrating a structure of a foldable and portable electric mobility apparatus in a folded state according to some embodiments of the present disclosure. FIG. 29 is a left view illustrating a foldable and portable electric mobility apparatus during folding according to some embodiments of the present disclosure. FIG. 30 is a schematic diagram illustrating a structure of a foldable and portable electric mobility apparatus in a folded state according to some embodiments of the present disclosure. FIG. 31 is a left view illustrating a structure of a foldable and portable electric mobility apparatus in an unfolded state according to some embodiments of the present disclosure.

Embodiments of the present disclosure also provide another type of electric mobility apparatus 100, as shown in FIGS. 26-31. The electric mobility apparatus 100 is a portable and foldable electric mobility apparatus, including a front-wheel frame assembly 200 and a rear wheel frame assembly 300. The front wheel frame assembly 200 and the rear wheel frame assembly 300 form an approximate X-shape, constituting a main framework of the electric mobility apparatus 100.

In some embodiments, as shown in FIG. 27, the front wheel frame assembly 200 includes a seat surface bracket 201 configured for a rider to ride when using the electric mobility apparatus 100.

In some embodiments, the rear wheel frame assembly 300 includes an armrest assembly 301. The armrest assembly 301 may be configured for the rider to support his or her hands when using the electric mobility apparatus 100, and the armrest assembly 301 may provide a corresponding control button for controlling a movement of the electric mobility apparatus 100.

In some embodiments, the front wheel frame assembly 200 is rotatably connected to the rear wheel frame assembly 300 via a rotating shaft E. The front wheel frame assembly 200 and the rear wheel frame assembly 300 are rotatably connected via the rotating shaft E to achieve relative rotational movement, such as rotating to fold together or rotating to unfold, allowing the electric mobility apparatus 100 to be folded to reduce a size of the electric mobility apparatus 100 for storage.

In some embodiments, the electric mobility apparatus 100 further includes a backrest bracket 500 rotatably connected to the seat surface bracket 201 of the front wheel frame assembly 200. For example, the backrest bracket 500 may be hingedly connected to the seat surface bracket 201 to achieve a relative rotational movement.

The backrest bracket 500 may be configured for the rider to recline against in a usage state, allowing the rider to sit more comfortably in the electric mobility apparatus 100.

In some embodiments, the electric mobility apparatus further includes a connecting member 700. For example, the connecting member may be a folding linkage, and one end of the folding linkage may be rotatably connected to the armrest bracket 3011 of the armrest assembly 301. Exemplarily, one end of the folding linkage may be hingedly connected to the armrest bracket 3011 of the armrest assembly 301 for relative rotation. Another end of the folding linkage may be rotatably connected to the backrest bracket 500. Exemplarily, the another end of the folding linkage may be hinged to the backrest bracket 500 for relative rotation.

The front wheel frame assembly 200, the rear wheel frame assembly 300, the backrest bracket 500, and the folding linkage may form a quadrilateral linkage mechanism through the rotating shaft E and hinge structures between each other. In the quadrilateral linkage mechanism, the front wheel frame assembly 200 corresponds to a bottom side of the quadrilateral linkage mechanism, the rear wheel frame assembly 300 corresponds to a left side of the quadrilateral linkage mechanism, the backrest bracket 500 corresponds to a right side of the quadrilateral linkage mechanism, and the folding linkage corresponds to a top side of the quadrilateral linkage mechanism.

The quadrilateral linkage mechanism allows for mutual rotational changes, where a rotation of one side may drive a corresponding rotational movement of other sides. Exemplarily, as shown in FIGS. 28-29, the backrest bracket 500 may swing back and forth relative to the seat surface bracket 201. For example, when the backrest bracket 500 swings backward toward the seat surface bracket 201, the backrest bracket 500 rotates around a hinge point between the backrest bracket 500 and the seat surface bracket 201. Through the folding linkage, the armrest assembly 301 is driven to rotate in a direction of the backrest bracket 500, bringing the armrest assembly 301 closer to the backrest bracket 500 and the seat surface bracket 201. When the backrest bracket 500 swings backward to a certain distance from the seat surface bracket 201, i.e., when the backrest bracket 500 has rotated backward by a certain angle, the armrest assembly 301 is approximately parallel to the backrest bracket 500. At this point, an angle between the top side of the quadrilateral linkage mechanism formed by the folding linkage and the right side of the quadrilateral linkage mechanism formed by the backrest bracket 500 becomes very small. Similarly, an angle between the left side of the quadrilateral linkage mechanism formed by the armrest assembly 301 and the bottom side of the quadrilateral linkage mechanism formed by the seat surface bracket 201 also becomes very small. Subsequently, the backrest bracket 500 rotates toward the seat surface bracket 201 around the hinge point between the backrest bracket 500 and the seat surface bracket 201 until the backrest bracket 500 is close to the seat surface bracket 201, thereby achieving the overall folding of the electric mobility apparatus 100 (i.e., realizing the electric mobility apparatus 100 in the folded state).

In some embodiments, the front wheel frame assembly 200 further includes a front frame 201, and the rear wheel frame assembly 300 further includes a rear frame 302. The front frame 201 is rigidly connected to the seat surface bracket 201, the rear frame 302 is rigidly connected to the armrest assembly 301, and the front frame 201 is rotatably connected to the rear frame 302 through the rotating shaft E, so that a movement of the seat surface bracket 201 directly drives a movement of the front frame 202, and a movement of the armrest assembly 301 directly drives a movement of the rear frame 302, which makes the front frame 202 and the rear frame 302 to rotate relative to each other around the rotating shaft E, thereby allowing the front frame 202 and the rear frame 302 to fold and come closer to each other or to unfold and separate from each other.

In some embodiments, the front wheel frame assembly 200 further includes a pedal member 203, the pedal member 203 is configured for foot support of a rider when the electric mobility apparatus 100 is in a usage state.

In some embodiments, the pedal member 203 is rigidly connected to the front frame 202, such that the pedal member 203 may rotate along with the rotational movement of the front frame 202. Consequently, in the folded state of the electric mobility apparatus 100, the pedal member 203 folds and moves closer to the rear frame 302 together with the front frame 202.

In some embodiments, the front frame 202 is rigidly connected with front wheels 205, and the rear frame 302 is rigidly coupled with rear wheels 303. The front wheels 205 are universal wheels configured to adjust a moving direction of the electrical mobility apparatus 100, and the rear wheels 303 are configured to provide a driving force. The front wheels 205 and the rear wheels 303 together support the electric mobility apparatus 100 to enable the electric mobility apparatus 100 to move in the usage state.

As shown in FIG. 30-FIG. 31, when the electric mobility apparatus 100 is in the folded state, the front wheels 205 and the rear wheels 303 move close to each other and are suspended from the ground. A distance between the front wheels 205 and the rear wheels 303 suspending from the ground may be less than 10 cm. For example, the distance between the front wheels 205 and the rear wheels 303 suspending from the ground may be less than 1 cm.

In some embodiments, the pedal member 203 further includes a front support wheel 204, the front support wheel 204 being disposed below the pedal member 203.

When the electric mobility apparatus 100 is in the usage state, the front support wheel 204 is suspended from the ground, and the electric mobility apparatus 100 is supported by the front wheels 205 and the rear wheels 303. A distance between the front support wheel 204 and the ground may be less than 10 cm. For example, the distance between the front support wheel 204 and the ground may be less than 3 cm.

When the electric mobility apparatus 100 is in the folded state, the front support wheel 204 is in contact with the ground after folding together with the pedal member 203 and support the electric mobility apparatus 100 to move. At this time, the front wheels 205 and the rear wheels 303 are suspended from the ground and do not participate in the support and movement of the electric mobility apparatus 100.

In some embodiments, the rear wheels 303 are further connected to a rear anti-tip member 304, which may be configured to support the electric mobility apparatus 100 in the event of a sudden situation that causes the electric mobility apparatus 100 to tip backward when the electric mobility apparatus 100 is in the usage state. Therefore, in the usage state, the rear anti-tip member 304 is positioned closer to a rear side of the electric mobility apparatus 100 than the rear wheels 303.

A rear support wheel 305 may be provided at a rear end of the rear anti-tip member 304, so that when an unexpected situation occurs that causes the electric mobile apparatus 100 to tip backward, the rear support wheel 305 may timely support the electric mobile apparatus 100 and prevent the electric mobile apparatus from further tipping over.

In the usage state, the rear support wheel 305 is suspended from the ground, and a distance between the rear support wheel 305 and the ground may be less than 10 cm. For example, the distance between the rear support wheel 305 and the ground may be less than 3 cm.

In the folded state, the rear support wheel 305 may contact with the ground and support the electric mobility apparatus 100 to move.

In some embodiments, a first limiting mechanism (not shown in the accompanying drawings) is provided between the front wheel frame assembly 200 and the rear wheel frame assembly 300. The first limiting mechanism may be configured to limit a distance between the front wheels 205 and the rear wheels 303 in the usage state, thereby ensuring that the distance between the front wheels 205 and the rear wheels 303 may not be reduced suddenly in the usage state of the electric mobility apparatus 100, which may cause the electric mobility apparatus 100 to fold unexpectedly.

When the electric mobility apparatus 100 needs to be folded, the first limiting mechanism may be released, thereby allowing the front wheels 205 and the rear wheels 303 to move closer normally.

In some embodiments, a second limiting mechanism (not shown in the accompanying drawings) is also provided between the front wheel frame assembly 200 and the rear wheel frame assembly 300. The second limiting mechanism may be configured to limit a distance between the front wheels 205 and the rear wheels 303 in the folded state, so that the distance between the front wheels 205 and the rear wheels 303 may not be increased suddenly in the folded state of the electric mobility apparatus 100, which may cause the electric mobility apparatus 100 to unfold unexpectedly.

When the electric mobility apparatus 100 needs to be unfolded to the usage state, the second limiting mechanism may be released, thereby allowing the front wheels 205 and the rear wheels 303 to separate normally.

In some embodiments, the backrest bracket 500 further includes one or more handles 600, the one or more handles 600 may be disposed at an upper end of the backrest bracket 500 for a user to hold on to push the electric mobility apparatus 100 while the electric mobility apparatus 100 is in the usage state. In addition, the one or more handles 600 may also be provided with an operation point for the user when the user needs to fold the electric mobility apparatus 100. The user may simply hold the one or more handles 600 and flip the one or more handles 600 backward, which causes the backrest bracket 500 to flip backward and then fold toward the seat surface bracket 201, thereby completing the folding of the electric mobility apparatus 100.

Since the one or more handles 600 are located at the upper end of the backrest bracket 500, i.e., the one or more handles 600 are located on an extended line of one side of the backrest bracket 500 of the quadrilateral linkage mechanism, a relatively long lever arm may be provided when operating the one or more handles 600. The extended line forms a labor-saving lever, making the folding operation easier for the user. Additionally, because the one or more handles 600 are disposed at a uppermost end of the electric mobility apparatus 100 and are relatively high, the user may perform the folding operation through the one or more handles 600 without bending over, which is convenient for users, especially elderly users, thereby enhancing the overall user experience.

In some embodiments of the present disclosure, the front wheel frame assembly, the rear wheel frame assembly, and the backrest bracket are rotatably connected through the folding linkage to form the quadrilateral linkage mechanism. By utilizing kinematic properties of the quadrilateral linkage mechanism, flipping any one side of the quadrilateral linkage mechanism allows the other three sides to fold synchronously, thereby achieving the folding of the electric mobility apparatus 100.

The operation point for folding the electric mobility apparatus 100 is on the backrest. When an operation height of the backrest is relatively high, the folding and unfolding operations of the electric mobility apparatus may be more ergonomically friendly for the user, thereby requiring less effort and reducing the need for bending over, which is particularly advantageous for elderly users.

The folding operation point is on the one or more handles 600, which are located on the extended line of one side of the backrest bracket of the quadrilateral linkage mechanism. The relatively long lever arm created by this configuration acts as a labor-saving lever.

Some embodiments of the present disclosure provide a method for folding an electric mobility apparatus, which may include the following operations.

First, the backrest bracket 500 may be rotated backwardly. Exemplarily, by rotating the one or more handles 600 at the upper end of the backrest bracket 500 backward, an angle between the backrest bracket 500 and the folding linkage starts to decrease until the folding linkage and the backrest bracket 500 are approximately parallel. At this point, the front frame 202 rotates around the rotating shaft E and moves closer to the rear frame 302, causing the front wheels 205 driven by the front frame 202 and the rear wheels 303 driven by the rear frame 302 to move closer to each other.

Then, the backrest bracket 500 may be rotated in a direction of the seat surface bracket 201 until the backrest bracket 500 and the seat surface bracket 201 are close to each other, at which time, the front frame 202 may further move closer to the rear frame 302 until the front wheels 205 and the rear wheels 303 are close to each other.

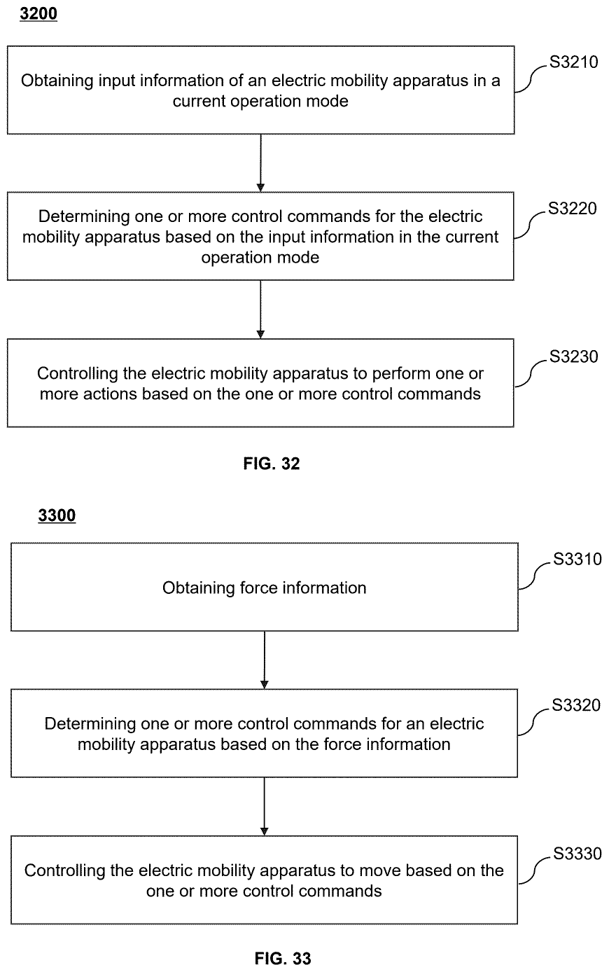

FIG. 32 is a flowchart illustrating an exemplary control process for an electric mobility apparatus according to some embodiments of the present disclosure. As shown in FIG. 32, a process 3200 includes the following operations S3210-S3230. In some embodiments, the process 3200 may be executed by a processor.

In S3210, input information of the electric mobility apparatus in a current operation mode may be obtained.

The operation mode refers to a working mode or a usage mode of the electric mobility apparatus. For example, the operation mode may include a riding mode, a push mode, a lying mode, etc. The current operation mode refers to an operation mode currently executed by the electric mobility apparatus.

In some embodiments, the electric mobility apparatus has two usage modes, i.e., the “riding mode” and the “push mode.” The riding mode refers to a mode in which the electric mobility apparatus is moved by a user riding the electric mobility apparatus. For example, the riding mode may be a mode in which a first user rides the electric mobility apparatus and controls a movement of the electric mobility apparatus by utilizing an operation device (e.g., an operating lever) provided on the electric mobility apparatus. The push mode refers to a mode in which a user who is not riding the electric mobility apparatus controls the movement of the electric mobility apparatus. For example, the push mode may be a mode in which the first user rides the electric mobility apparatus, and a second user pushes the electric mobility apparatus behind the electric mobility apparatus to control the movement of the electric mobility apparatus, or the first user does not ride the electric mobility apparatus, and the first user pushes the electric mobility apparatus behind the electric mobility apparatus to control the movement of the electric mobility apparatus.

In a scenario where the first user rides the electric mobility apparatus and the second user pushes the electric mobility apparatus behind the electric mobility apparatus in the push mode, the first user may indicate a rider and the second user may indicate a caregiver. The rider may be a patient who is unable to walk, or a user with a leg limitation (also referred to as a rehabilitator) who needs to use the electric mobility apparatus for rehabilitation. For example, the first user may be a user who is required to ride the electric mobility apparatus, and the second user may be a user who is responsible for taking care of the first user. In a scenario where the first user pushs the electric mobility apparatus behind the electric mobility apparatus, there is no rider, and the first user may indicate the rehabilitator. For example, the first user may be a user with a leg limitation who needs to use the electric mobility apparatus for rehabilitation.

The input information refers to information transmitted to the electric mobility apparatus by a user or other devices. For example, the input information may include force information transmitted by a sensor to the processor. As another example, the input information may include information entered by a user via an operation device.

In some embodiments, the processor may obtain the input information of the electric mobility apparatus in the current operating mode in a variety of ways. For example, the processor may obtain the input information input by the user based on the operation device. As another example, when the user operates the electric mobility apparatus, the processor may determine the input information based on information characterized by a sensor (e.g., a force sensor, a torque sensor, etc.).

In some embodiments, obtaining the input information of the electric mobility apparatus in a current operation mode may include: detecting an operation mode currently executed by the electric mobility apparatus; and obtaining the input information based on the operation mode currently executed by the electric mobility apparatus.

In some embodiments, the processor may detect the operation mode currently executed by the electric mobility apparatus in a variety of ways. For example, the processor may detect the operation mode currently executed by the electric mobility apparatus by detecting a signal from the sensor (e.g., the force sensor and the load sensor described above). In some embodiments, obtaining the input information based on the operating mode currently executed by the electric mobility apparatus may include: obtaining only input information related to the current operating mode.

In some embodiments, detecting the operation mode currently executed by the electric mobility apparatus may include: receiving a mode selection signal; and determining, based on the mode selection signal, the operation mode currently executed by the electric mobility apparatus.

The mode selection signal refers to a signal related to mode selection. In some embodiments, receiving the mode selection signal may include: detecting a trigger signal of at least one device of the electric mobility apparatus, and determining the mode selection signal based on the trigger signal. The trigger signal may include at least one of triggering input information received by the at least one device, posture information of the at least one device, and information of a force applied to the at least one device.

The trigger signal is a signal for trigger the mode selection. In some embodiments, the processor may determine the mode selection signal based on the trigger signal in multiple ways. For example, the processor may determine the mode selection signal based on a preset rule. Exemplarily, the preset rule may include correspondences between one or more trigger signals and the operation mode. In some embodiments, the processor may detect the trigger signal by communicating with the at least one device (e.g., the operation device, the push device, etc., described above) of the electric mobility apparatus.

The trigger input information received by the at least one device may include an operation mode selected by the user via the operation device (e.g., a lever, a button, etc). For example, the triggering input information may be information generated by the user pressing a mode selection button. As another example, the triggering input information may be information tapped by the user on a mode selection interface. The posture information of the at least one device may include an orientation, an unfolding state, a rotation position, etc., of the at least one device (e.g., the one or more pushing handles). For example, the posture information may include the one or more pushing handles being located in a forward-facing position, etc. The information of the force applied to the at least one device is information related to the force applied to the electric mobility apparatus. For example, the information of the force applied to the at least one device may include load information of the electric mobility apparatus, a force applied on the pushing handles, or the like.

The processor may identify the mode selection signal from the trigger signal. For example, if detecting via the operation device that the triggering input information is the user selecting the riding mode, the processor may identify the mode selection signal as the riding mode based on the triggering input information. As another example, if detecting that the one or more pushing handles are adjusted by the user to a posture suitable for pushing (e.g., the rearward-facing position shown in FIG. 18), the processor may determine that the mode selection signal is the push mode based on the posture information. As yet another example, if detecting that the user inputs a force or a torque on the push device, the processor may determine that the mode selection signal is the push mode based on the force or the torque applied on the push device.

In some embodiments, the trigger signal may include a mode refinement signal. The mode refinement signal is a signal that further subdivides the operation mode. More descriptions of the mode refinement signal may be found in related descriptions below.

In S3220, one or more control commands may be determined for the electric mobility apparatus based on the input information in the current operation mode.

The one or more control commands refer to one or more commands for controlling the electric mobility apparatus. For example, the one or more control commands may include switching the operation mode, adjusting a velocity of the electric mobility apparatus, or the like.

In some embodiments, based on the input information, the processor may determine the one or more control commands for the electric mobility apparatus in various ways. For example, the processor may determine the one or more control commands based on the input information by querying a first preset relationship table. The first preset relationship table may include a plurality of pieces of input information and a control command corresponding to each of the plurality of pieces of input information. The first preset relationship table may be constructed based on historical data or historical experience of those skilled in the art. As another example, the processor may determine the one or more control commands based on the input information via a preset algorithm. Exemplarily, the preset algorithm may be a calculation formula for determining a rotation direction of the electric mobility apparatus based on a force direction characterized by the torque sensor.

In some embodiments, the control method for the electric mobility apparatus may further include: obtaining related information of the electric mobility apparatus when the electric mobility apparatus is moving, and adjusting the one or more control commands based on the related information. The related information includes at least one of load information of the electric mobility apparatus or road condition information corresponding to the electric mobility apparatus.

The load information refers to a load condition of the electric mobility apparatus, for example, whether there is a user riding on the electric mobility apparatus, a weight of a load on the electric mobility apparatus, etc. The road condition information refers to a road condition during the movement of the electric mobility apparatus. For example, the road condition information may include whether a road on which the electric mobility apparatus moves is flat or not, a slope of the road, etc. In some embodiments, the processor may obtain the related information in multiple ways. For example, the processor may obtain the load information via a load sensor. As another example, when the electric mobility apparatus is in a folded state, the processor may directly determine a load weight in the load information being empty. In some embodiments, the processor may obtain the road condition information via a vibration sensor or an optical detection assembly.

In some embodiments, the processor may determine environmental information collected by the optical detection assembly of the electric mobility apparatus when the electric mobility apparatus is moving, and determine the road condition information based on the environmental information. More descriptions of the optical detection assembly may be found in related descriptions above.

The environmental information is information related to an environment in which the electric mobility apparatus is located. For example, the environmental information may include sidewalks, grass, etc.

In some embodiments, the processor may determine the road condition information based on the environmental information in a variety of ways. For example, the processor may determine the road condition information by querying a third preset relationship table based on the environmental information. The third preset relationship table may include a plurality of pieces of environmental information and road condition information corresponding to each of the plurality of pieces of environmental information. The third preset relationship table may be constructed based on historical data or historical experience of those skilled in the art. As another example, the processor may determine the road condition information based on the environmental information via a preset algorithm. Exemplarily, if the environmental information collected by the optical detection assembly is image data, the preset algorithm may be an image recognition algorithm, and the processor may determine the road condition information based on an image recognition result of the image recognition algorithm.

In some embodiments, the processor may adjust the one or more control commands based on the related information in a variety of ways. For example, when the load weight is empty and the electric mobility apparatus is not in the push mode, the processor may adjust the one or more control commands to be a control command instructing a braking device of the electric mobility apparatus to brake. As another example, when the road condition does not satisfy a preset condition (e.g., a condition indicating a safe movement of the electric mobility apparatus), the processor may adjust the one or more control commands to be a control command instructing the braking device of the electric mobility apparatus to brake. As yet another example, when the load weight is not empty, the electric mobility apparatus is not in the push mode, and the input information is not obtained, the processor may adjust the one or more control commands to be a control command instructing the braking device of the electric mobility apparatus to brake. More descriptions of this embodiment may be found in related descriptions below.

In S3230, the electric mobility apparatus may be controlled to perform one or more actions based on the one or more control commands.

In some embodiments, based on the one or more control commands, the processor may control the electric mobility apparatus to perform one or more actions in various ways. For example, the processor may control the electric mobility apparatus to perform one or more actions by querying a second preset relationship table based on the one or more control commands. The second preset relationship table includes control commands and executed actions corresponding to the control commands. The second preset relationship table may be constructed based on historical data or historical experience of those skilled in the art.

In some embodiments, based on the one or more control commands, the processor may control one or more driving devices of the electric mobility apparatus to perform one or more corresponding actions through a target driving parameter. More descriptions of this embodiment may be found in related descriptions below.

In the push mode, the user is required to push the electric mobility apparatus behind the electric mobility apparatus. In the prior art, the user often needs to exert a great force to push the electric mobility apparatus, especially in a zero-velocity starting phase. Additionally, it is difficult for the user to flexibly control the direction of the electric mobility apparatus, which results in a poor user experience and poses potential safety hazards.

Some embodiments of the present disclosure provide the control method for the electric mobility apparatus, which makes it easier for users to operate and control the electric mobility apparatus while also offering higher safety.

In some embodiments, the current operation mode may include the push mode, and obtaining the input information of the electric mobility apparatus in the current operation mode may include: obtaining force information input by the user to the electric mobility apparatus. In some embodiments, determining the one or more control commands for the electric mobility apparatus based on the input information in the current operation mode may include: determining the one or more control commands based on the force information.

The force information refers to information related to a force. The force information may include a torque, a force magnitude, a force direction, etc., of a force.

The processor may obtain the force information via the aforementioned force sensor or torque sensor. In the push mode, the user who inputs the force information to the electric mobility apparatus may be the first user or the second user.

In some embodiments, the processor may determine the one or more control commands based on the force information in a variety of ways. For example, the aforementioned first preset relationship table may further include a plurality of pieces of force information and control commands corresponding to the plurality of pieces of force information. The processor may determine the one or more control commands by querying the first preset relationship table based on the force information.

In some embodiments, to obtain the force information input by the user to the electric mobility apparatus, the processor may be configured to: obtain a first torque acting at a first position of the electric mobility apparatus. In some embodiments, to obtain the force information input by the user to the electric mobility apparatus, the processor may be configured to: obtain a second torque acting at a second location of the electric mobility apparatus.

In some embodiments, the processor may obtain the first torque or the second torque. Alternatively, the processor may obtain both the first torque and the second torque. In some embodiments, the processor may further determine the one or more control commands based on at least one of the first torque or the second torque.

In some embodiments, the electric mobility apparatus includes the push device, with the first position and the second position located on the push device. More descriptions of the push device may be found in related descriptions above.

In some embodiments, the push device may include two pushing handles (e.g., the handles 600 shown in FIG. 17), with the first position and the second position being positions located on two different pushing handles, respectively. In some embodiments, the push device may include one pushing handle, the first position and the second position being two different positions on the same pushing handle.

In some embodiments, in response to obtaining a force magnitude and a force direction of the first torque, or obtaining a force magnitude and a force direction of the second torque (e.g., when the user operates the push device with one hand), the processor may determine a control command instructing the electric mobility apparatus to move based on the force direction and force magnitude of the first torque or the force direction and force magnitude of the second torque. For example, the processor may determine a current moving direction of the electric mobility apparatus based on the force direction, determine a current moving velocity of the electric mobility apparatus based on a correspondence between the force magnitude and the velocity, and determine the control command instructing the electric mobility apparatus to move based on the current moving direction and the current moving velocity.

In some embodiments, to determine the one or more commands based on the force information, the processor may be configured to: in response to determining that the first torque and the second torque are obtained simultaneously, determine, based on a first relationship between the force direction characterized by the first torque and the force direction characterized by the second torque and a second relationship between the force magnitude characterized by the first torque and the force magnitude characterized by the second torque, the control command instructing the electric mobility apparatus to move. For example, the first relationship may include a relationship (e.g., an angle) between the force direction characterized by the first torque and the force direction characterized by the second torque. The second relationship may include a relationship (e.g., a difference, a maximum value) between the force magnitude characterized by the first torque and the force magnitude characterized by the second torque, etc.

In some embodiments, in response to determining that the angle between the force direction characterized by the first torque and the force direction characterized by the second torque is less than a first threshold, and the difference between the force magnitude characterized by the first torque and the force magnitude characterized by the second torque is less than a second threshold, the processor may determine a control command instructing the electric mobility apparatus to perform a linear movement.

In some embodiments, in response to determining that the angle between the force direction characterized by the first torque and the force direction characterized by the second torque is not less than the first threshold, and the difference between the force magnitude characterized by the first torque and the force magnitude characterized by the second torque is not less than the second threshold, the processor may determine a control command instructing the electric mobility apparatus to perform a steering movement.

The first threshold and the second threshold may be system default values or pre-set by the user. For example, the first threshold and the second threshold may be set to 0. If the angle between the force direction characterized by the first torque and the force direction characterized by the second torque is less than 0, and the difference between the force magnitude characterized by the first torque and the force magnitude characterized by the second torque is less than 0, the processor may determine the control command instructing the electric mobility apparatus to perform a linear movement. More descriptions of the embodiment may be found in related descriptions below.

In some embodiments, to determine the one or more control commands based on the force information, the processor may be configured to: determine, based on a force magnitude characterized by the force information, a control command instructing the braking device of the electric mobility apparatus to perform an action.

In some embodiments, the electric mobility apparatus further includes the braking device. For example, the braking device may include an electromagnetic brake, an electronic brake, or the like.

In some embodiments, in response to determining that the force magnitude characterized by the force information is greater than a preset value (e.g., 0), the processor may determine a control command instructing the braking device of the electric mobility apparatus to release braking.

In some embodiments, in response to determining that the force magnitude characterized by the force information is less than or equal to the preset value, the processor may determine a control command instructing the braking device of the electric mobility apparatus to brake. The third threshold is similar to the first threshold and is not described here.

In some embodiments, to determine the one or more control commands based on the force information, the processor may be configured to: determine, based on the force information, a first control parameter for controlling a movement of the electric mobility apparatus in a linear direction and a second control parameter for controlling a movement of the electric mobility apparatus in a non-linear direction, and determine the one or more control commands for the electric mobility apparatus based on the first control parameter and the second control parameter.

The control parameter refers to a parameter related to the control of the electric mobility apparatus. In some embodiments, the control parameter includes a control force.

In some embodiments, the processor may determine the control parameter (e.g., the first control parameter and the second control parameter) based on the force information in a variety of ways. Exemplarily, the processor may decompose the force information into a force direction and a force magnitude, thereby determining the control parameter.

In some embodiments, the first control parameter includes a first control force, and the second control parameter includes a second control force. The processor may determine, based on the first control force and the second control force, a target driving parameter for one or more driving devices of the electric mobility apparatus, wherein the one or more driving devices are drivably connected to at least one wheel of the electric mobility apparatus.

A driving parameter is an available parameter for the driving device. The target driving parameter is a driving parameter that is used by the one or more driving devices to control the at least one wheel. Exemplarily, the driving parameter may include an acceleration, a linear velocity, and an angular velocity; and the target driving parameter may include a target acceleration, a target linear velocity, and a target angular velocity.

In some embodiments, the target driving parameter includes a first target driving parameter and a second target driving parameter, the first target driving parameter and the second target driving parameter being used for controlling a different wheel of the electric mobility apparatus, respectively.

In some embodiments, to determine, based on the first control force and the second control force, the target driving parameter for the one or more driving devices of the electric mobility apparatus, the processor may be further configured to: determine a target linear velocity and a target angular velocity of the electric mobility apparatus based on the first control force and the second control force, and determine the target driving parameter based on the target linear velocity and the target angular velocity of the electric mobility apparatus.

In some embodiments, in response to determining that the force information does not satisfy a preset condition, the processor may determine a control command instructing the electric mobility apparatus to stop moving. The preset condition is a condition indicating a safe movement of the electric mobility apparatus. Exemplarily, the preset condition may include the force magnitude of the force information being greater than 0 when the road slope is not 0 in the push mode.

More descriptions of this embodiment may be found in related descriptions below.

In some embodiments, the control method for the electric mobility apparatus may include: obtaining force information of the input information; determining, based on the force information, one or more control commands for the electric mobility apparatus; and controlling the electric mobility apparatus to move based on the one or more control commands.

FIG. 33 is a flowchart of a control process for an electric mobility apparatus according to some embodiments of the present disclosure. As shown in FIG. 33, a process 3300 may include the following operations S3310-S3330. In some embodiments, the process 3300 may be implemented by a processor.

In S3310, force information may be obtained.

The force information may be configured to instruct the electric mobility apparatus to move. The force information may be input by a user to the electric mobility apparatus. The force information is referred to as input force information. In other words, when the user has a need to control the electric mobility apparatus to move, the user may input the force information to the electric mobility apparatus to instruct the electric mobility apparatus to move.

Some embodiments of the present disclosure are not limiting with respect to the manner in which the force information is obtained. The processor may obtain the force information in various ways. For example, the force information may be obtained by pushing a push device, touching the push device, or triggering a plurality of keys of the push device, or based on a voice input by the user. As another example, the processor may obtain the force information by collecting sensor data from a sensor (e.g., a force sensor and a torque sensor).

In some embodiments of the present disclosure, the force information characterizes at least one of a force direction or a force magnitude. That is to say, the force information may include information in at least one of the direction or the magnitude. By obtaining the force information, the user's needs with respect to a movement direction and a movement distance of the electric mobility apparatus may be obtained.

In S3320, the one or more control commands for the electric mobility apparatus may be determined based on the force information.

In some embodiments of the present disclosure, the one or more control commands may include at least one of a command instructing the movement direction or a command instructing a movement velocity. It is understood that since the force information in both the direction and magnitude dimensions is obtained in some embodiments of the present disclosure, the processor may recognize, based on the force information, the intention of the user to instruct the electric mobility apparatus to move, and thus control the electric mobility apparatus to move in the movement direction and the movement velocity.

In S3330, the electric mobility apparatus may be controlled to move based on the one or more control commands.

In some embodiments, after the processor determines the one or more control commands for the electric mobility apparatus, the processor may control the electric mobility apparatus to move based on at least one of the movement direction or the movement velocity indicated by the one or more control commands. More descriptions regarding the processor controlling the electric mobility apparatus to move based on the one or more control commands may be found in the present disclosure below.

Since the one or more control commands are determined based on the force information of the push device and the information in the force direction and the force magnitude are both considered, the electric mobility apparatus may be controlled to move based on the one or more control commands, such that the movement of the electric mobility apparatus may match the force information input by the user.

According to the control method for the electric mobility apparatus provided in some embodiments of the present disclosure, by obtaining the force information characterizing the force direction and the force magnitude, and determining at least one of the control command instructing the movement direction or the control command instructing the movement velocity based on the force information in the direction dimension and the magnitude dimension, so as to make the movement control of the electric mobility apparatus more closely match the force information, reduce the input force required for controlling the movement of the electric mobility apparatus, and achieve more flexible and “smooth” movement of the electric mobility apparatus. In some embodiments, the electric mobility apparatus may include the push device. In this case, the processor may obtain the force information of the push device.

The push device of the electric mobility apparatus may be understood as a device deployed in the electric mobility apparatus for a non-rider to control the movement of the electric mobility apparatus. For example, the push device may include one or more pushing handles (e.g., the handles 600 in FIG. 17). The user located behind the electric mobility apparatus may control the movement of the electric mobility apparatus through the one or more pushing handles.

In some embodiments, the force information may include a torque. For example, the processor may obtain the force information of the push device by collecting a first torque acting at a first position of the push device and collecting a second torque acting at a second position of the push device. That is, a torque sensor may be disposed in the push device. The torque sensor may be configured to collect a force magnitude and a force direction. The processor may obtain the force information by acquiring a signal collected by the torque sensor.

The torque sensor may include two torque sensors in a one-dimensional direction or one torque sensor in a two-dimensional direction. In this case, the torque sensor may collect the force information of forward and backward force directions, and collect force information of left and right force directions.

In some embodiments of the present disclosure, the processor may obtain torques acting at two positions of the push device. In some embodiments, the first position and the second position may represent positions where the user's hands are located, respectively. That is, when the user pushes or pulls the push device, the torque sensor may collect the torques applied by both of the user's hands, respectively.

The first position and the second position may be different depending on the type of the push device. In some embodiments, the push device may include a first pushing handle and a second pushing handle. In this case, the processor may collect the first torque acting on the first pushing handle, and collect the second torque acting on the second pushing handle.

In some embodiments, the push device may include only a third pushing handle. In this case, the processor may collect a first torque acting on a left region of the third pushing handle, and collect a second torque acting on a right region of the third pushing handle.

In some embodiments, if the push device includes only the third pushing handle, the first position may be provided in a middle region of the third pushing handle. The processor may only collect a first torque acting in the middle region of the third pushing handle. That is, when the user operates with one hand, only the first torque may be collected.

The push device may include either two separate pushing handles or a single pushing handle (e.g., a pushing handle in the form of a crossbar). If the push device includes two separate pushing handles, the user may hold both hands on the two pushing handles to control the movement of the electric mobility apparatus. If the push device includes a single pushing handle, the user may hold both hands on the left region and the right region of the pushing handle, respectively, to control the movement of the electric mobility apparatus. If the push device includes the single pushing handle, the user may also operate with one hand by holding the middle region of the pushing handle to control the movement of the electric mobility apparatus.

In some embodiments, the processor may also control a braking device of the electric mobility apparatus in combination with the force information. The braking device may be an electromagnetic brake. The electromagnetic brake may be understood as a brake switch acting on one or more driving devices of the electric mobility apparatus. In response to determining that the electromagnetic brake is open, the one or more driving devices may normally drive the electric mobility apparatus. In response to determining that the electromagnetic brake is closed, the one or more driving devices may not drive the electric mobility apparatus.

Merely by way of example, in response to determining that a detected force magnitude characterized by the force information is not zero, the processor may control the braking device of the electric mobility apparatus to be opened. In other words, when the user inputs a force to the push device, such as when the user holds the pushing handle, it is indicated that the user may control the electric mobility apparatus to move. In this case, the processor may control the braking device of the electric mobility apparatus to be opened automatically without manual operation by the user, thereby reducing operation complexity.

For example, in response to determining that the detected force magnitude characterized by the force information is zero, the processor may control the braking device of the electric mobility apparatus to be closed. In other words, when the user stops inputting the force to the push device, such as when the user releases the pushing handle, it is indicated that the user does not need to control the electric mobility apparatus to move temporarily. In this case, the processor may control the braking device of the electric mobility apparatus to be automatically closed, thereby realizing “stop while releasing”, which can ensure the movement safety of the electric mobility apparatus.

In some embodiments, when only the first torque is collected (e.g., when operating with one hand), the processor may confirm the one or more control commands based on the first torque. For example, when the force direction characterized by the first torque is different from a linear movement direction of the electric mobility apparatus, a control command instructing the electric mobility apparatus to perform a steering movement may be determined. Otherwise, when the force direction characterized by the first torque is the same as the linear movement direction of the electric mobility apparatus, a control command instructing the electric mobility apparatus to perform a linear movement may be determined.

In some embodiments, the force information may include the first torque and the second torque. When the force direction characterized by the first torque and the force direction characterized by the second torque are the same, and the force magnitude characterized by the first torque and the force magnitude characterized by the second torque are the same, the processor may determine the control command instructing the electric mobility apparatus to perform the linear movement.

That is to say, when the force directions of the forces input by both hands of the user are the same, for example, both forward or backward, and the force magnitudes of the forces input by both hands of the user are the same, the processor may control the electric mobility apparatus to perform the linear movement, for example, to perform a forward or backward movement.

In some embodiments, the force information may include the first torque and the second torque. When the force direction characterized by the first torque and the force direction characterized by the second torque are different, or the force magnitude characterized by the first torque and the force magnitude characterized by the second torque are different, the processor may determine the control command instructing the electric mobility apparatus to perform the steering movement.

That is to say, when the force directions of the forces input by both hands of the user are different, or the force magnitudes of the forces input by both hands of the user are different, the processor may control the electric mobility apparatus to perform the steering movement, for example, to perform a leftward or rightward movement.

In this way, according to the force information in the force direction and the force magnitude, the user's intention to control the electric mobility apparatus to perform the linear movement or the steering movement can be determined, so as to realize the movement of the electric mobility apparatus with reference to the movement direction.

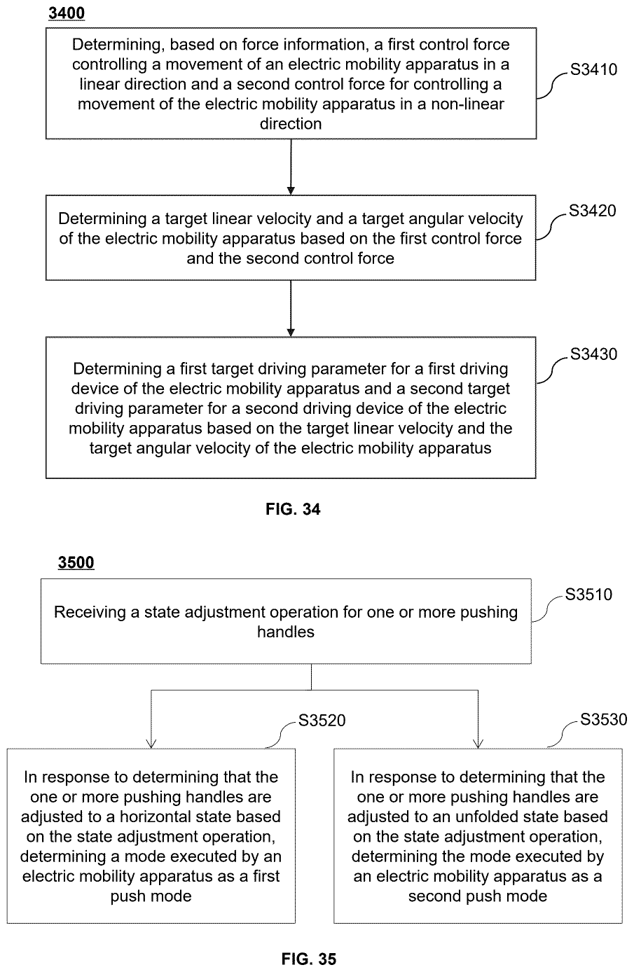

FIG. 34 is a flowchart illustrating an exemplary process for determining a driving parameter according to some embodiments of the present disclosure. As shown in FIG. 34, a process 3400 may include the following operations S3410-S3430. In some embodiments, the process 3400 may be implemented by a processor.

In S3410, a first control force for controlling a movement of an electric mobility apparatus in a linear direction and a second control force for controlling a movement of the electric mobility apparatus in a non-linear direction may be determined based on force information.

Since the force information characterizes a force direction and a force magnitude, the processor may convert the force information into the first control force for controlling the movement in the linear direction and the second control force for controlling the movement in the non-linear direction, thereby achieving force decomposition in different directions.

In some embodiments, when the force information generated by an external force is collected at only one position (e.g., when operating with one hand as previously described), the processor may confirm the first control force and the second control force based on the force information.

Then, the processor may determine, based on the first control force and the second control force, one or more control commands for the electric mobility apparatus. It is understood that after the force information is converted into control forces in different directions, flexible control for the electric mobility apparatus may be realized based on the control forces in different directions.

In some embodiments, the processor may determine, based on the first control force and the second control force, a first target driving parameter for a first driving device and a second target driving parameter for a second driving device of the electric mobility apparatus. For example, the first driving device may include a first motor, and the second driving device may include a second motor. The first motor may be configured to drive a left wheel of the electric mobility apparatus and the second motor may be configured to drive a right wheel of the electric mobility apparatus.

For example, the driving parameter may include a rotational velocity. Control of the electric mobility apparatus may be achieved by the rotational velocities of the first motor and the second motor. For example, when the rotational velocities of the first motor and the second motor are different, a steering movement may be realized.

In some embodiments of the present disclosure, after the force information is converted into control forces in different directions, the control forces in different directions may be converted into the first target driving parameter for the first driving device of the left wheel and the right target driving parameter for the right driving device of right wheel, such that the one or more driving devices may control the movement of the electric mobility apparatus using the target driving parameter.

In S3420, a target linear velocity and a target angular velocity of the electric mobility apparatus may be determined based on the first control force and the second control force. In S3430, the first target driving parameter for the first driving device in the electric mobility apparatus and the second target driving parameter for the second driving device in the electric mobility apparatus may be determined based on the target linear velocity and the target angular velocity of the electric mobility apparatus.

In some embodiments of the present disclosure, the control forces in different directions may be converted into linear and angular velocities desired by the electric mobility apparatus, and then the target driving parameter required by the one or more driving devices may be determined, so as to control the electric mobility apparatus to move.

In some embodiments, the one or more control commands may include a first target rotational velocity of the first motor and a second target rotational velocity of the second motor. In this case, the processor may control the first motor and the second motor to drive at the first target rotational velocity and the second target rotational velocity, respectively, to realize the movement of the electric mobility apparatus.

Merely by way of example, the force information may include a first torque and a second torque. The first torque is denoted as F_I and the second torque is denoted as F_r. The first control force and the second control force may be determined by the following equations (1) and (2):

$$F\_D = ( F\_I + F\_r ) / 2 \qquad ( 1 )$$

$$F\_T = ( F\_I - F\_r ) / 2 \qquad ( 2 )$$

wherein F_D denotes the first control force for controlling the movement of the electric mobility apparatus in the linear direction, and F_T denotes the second control force for controlling the movement of the electric mobility apparatus in the non-linear direction.

Then the target linear velocity and the target angular velocity of the electric mobility apparatus may be determined using a proportional integral (PI) controller. For example, the first control force F_D may be input into a first PI controller to obtain the target linear velocity of the electric mobility apparatus, denoted as L_v. The second control force F_T may be input into the second PI controller to obtain the target angular velocity of the electric mobility apparatus, denoted as A_v.

After the target linear velocity and the target angular velocity of the electric mobility apparatus are determined, the first target driving parameter for the first driving device in the electric mobility apparatus and the second target driving parameter for the second driving device in the electric mobility apparatus may be determined by the following equations (3) and (4):

$$V\_l = ( L\_v + A\_v ) / 2 \qquad ( 3 )$$

$$V\_r = ( L\_v - A\_v ) / 2 \qquad ( 4 )$$

wherein V_I denotes the first target driving parameter for the first driving device in the electric mobility apparatus, and V_r denotes the second target driving parameter for the second driving device in the electric mobility apparatus.

Considering the safe movement of the electric mobility apparatus, when the force information does not satisfy a preset condition, the electric mobility apparatus may also be controlled to stop moving. The preset condition refers to a condition indicating a safe movement of the electric mobility apparatus. That is to say, in response to determining that the force information does not enable the safe movement of the electric mobility apparatus, the electric mobility apparatus may be controlled to stop moving, and unsafe movement of the electric mobility apparatus may be avoided.

In some embodiments, the force information may include a first torque and a second torque. The first torque and the second torque may be collected by a torque sensor. The preset condition may be that the first torque or the second torque exceeds a collection threshold of the torque sensor. In this case, it is determined that the torque sensor fails. The electric mobility apparatus may be controlled to stop moving on the premise that the torque sensor fails, thereby avoiding the unsafe movement.

Some embodiments of the present disclosure are not limited with respect to the manner of controlling the electric mobility apparatus to stop moving. For example, the processor may control the electric mobility apparatus to stop moving by controlling a braking device to be closed. As another example, the processor may control the electric mobility apparatus to stop moving by setting the driving parameters for the first driving device and the second driving device to 0.

In some embodiments, force information of a push device may be understood to be information that is applied to the push device by a non-rider of the electric mobility apparatus for instructing the electric mobility apparatus to move. In other words, the control method for the electric mobility apparatus provided in some embodiments of the present disclosure may require the force information from the non-rider of the electric mobility apparatus to the push device.

In some embodiments, the processor may also detect a mode executed by the electric mobility apparatus. For example, the mode executed by the electric mobility apparatus may include a riding mode and a push mode. In the riding mode, a rider of the electric mobility apparatus may control the electric mobility apparatus to move through an operation device (e.g., an operating lever). In the push mode, the non-rider of the electric mobility apparatus may control the electric mobility apparatus to move through the force information from the non-rider to the push device.

In response to determining that the mode executed by the electric mobility apparatus is the push mode, the processor may obtain the force information of the push device. That is, the processor may determine whether to obtain the force information of the push device in conjunction with the mode executed by the electric mobility apparatus. The force information of the push device may be obtained only when the mode executed by the electric mobility apparatus is the push mode, thereby avoiding the waste of resources caused by long-time and continuous obtaining force information of the push device.

In some embodiments, the electric mobility apparatus may be provided with a mode selection device. In some embodiments, the mode selection device may be disposed on the electric mobility apparatus, such as a control panel of the electric mobility apparatus. In some embodiments, the mode selection device may also be provided independently of the electric mobility apparatus, such as being a separate remote control.

In some embodiments, the processor may receive a mode selection signal and determine, based on the mode selection signal, the mode executed by the electric mobility apparatus. In other words, the user may switch the mode executed by the electric mobility apparatus by performing mode selection through the mode selection device, and determine the mode executed by the electric mobility apparatus based on the mode selection signal.

In some embodiments, the user may determine the mode selection signal through other trigger signals. More descriptions regarding the trigger signal may be found in the present disclosure above.

The push mode may also be subdivided into a first push mode and a second push mode. The first push mode may be understood as a push mode in which a first user pushes the electric mobility apparatus behind the electric mobility apparatus. The second push mode may be understood as a push mode in which the first user rides the electric mobility apparatus, and a second user pushes the electric mobility apparatus behind the electric mobility apparatus.

Some embodiments of the present disclosure support the user switching between the first push mode and the second push mode. In some embodiments, the mode executed by the electric mobility apparatus may be the push mode and the push device may include one or more pushing handles.

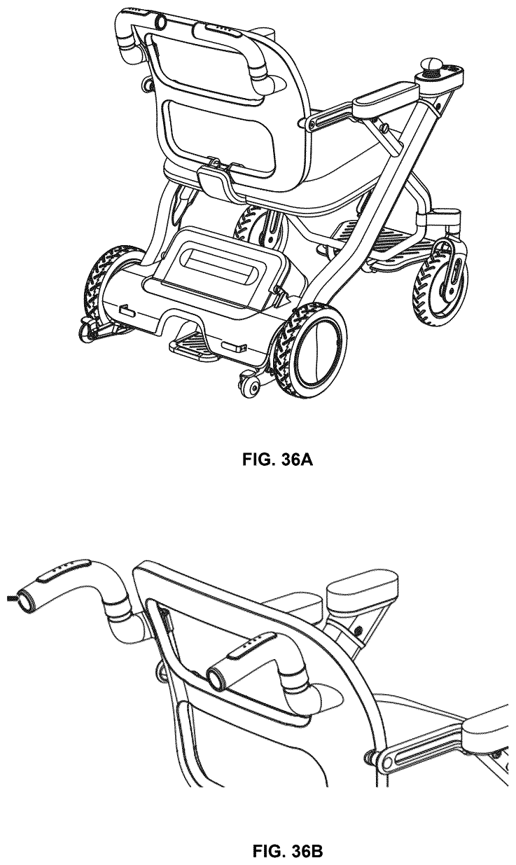

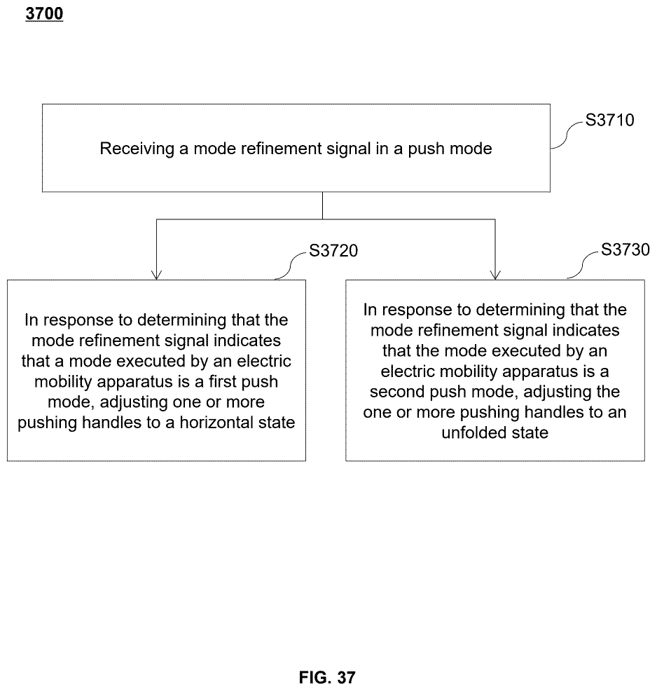

FIG. 35 is a flowchart illustrating an exemplary process for determining a push mode according to some embodiments of the present disclosure. As shown in FIG. 35, a process 3500 may include the following operations S3510-S3530. FIGS. 36A-36B are schematic diagrams illustrating a state of a pushing handle according to some embodiments of the present disclosure. FIG. 37 is a flowchart illustrating an exemplary process for adjusting a pushing handle according to some embodiments of the present disclosure. As shown in FIG. 37, a process 3700 may include the following operations S3710-S3730. In some embodiments, the process 3500 and the process 3700 may be implemented by a processor.

In S3510, a state adjustment operation for one or more pushing handles may be received. In S3520, in response to determining that the one or more pushing handles are adjusted to a horizontal state based on the state adjustment operation, a mode executed by an electric mobility apparatus may be determined as a first push mode. In S3530, in response to determining that the one or more pushing handles are adjusted to an unfolded state based on the state adjustment operation, the mode executed by the electric mobility apparatus may be determined as a second push mode.

The horizontal state characterizes that the one or more pushing handles are parallel to a backrest of the electric mobility apparatus. The unfolded state characterizes that the one or more pushing handles are non-parallel to the backrest of the electric mobility apparatus.

As shown in FIG. 36A, the one or more pushing handles may be parallel to the backrest of the electric mobility apparatus. In this case, the mode executed by the electric mobility apparatus may be the first push mode. As shown in FIG. 36B, the one or more pushing handles may be perpendicular to the backrest of the electric mobility apparatus. In this case, the mode executed by the electric mobility apparatus may be the second push mode.

In some embodiments, an operation device (e.g., a turn knob) may be disposed on the one or more pushing handles. When the user presses the turn knob, the state of the one or more pushing handle may be adjusted. In some embodiments, the user may also manually adjust the state of the one or more pushing handles.

In some embodiments of the present disclosure, switching between the first push mode and the second push mode can be realized by the state adjustment operation performed on the one or more pushing handle by the user, so as to allow the user to control the electric mobility apparatus to move in different scenarios based on actual use needs.

In some embodiments, the mode executed by the electric mobility apparatus may be the push mode, and the push device may include one or more pushing handles. In this case, referring to FIG. 37, the process 3700 may include the following operations. In S3710, a mode refinement signal in the push mode may be received. S3720, in response to determining that the mode refinement signal indicates that a mode executed by an electric mobility apparatus is a first push mode, one or more pushing handles may be adjusted to a horizontal state. In S3730, in response to determining that the mode refinement signal indicates that the mode executed by the electric mobility apparatus is a second push mode, one or more pushing handles may be adjusted to an unfolded state.

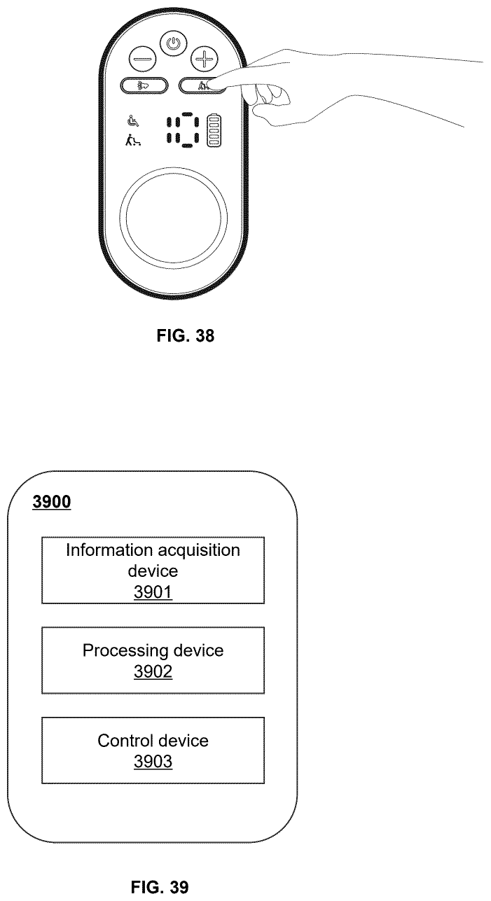

FIG. 38 is a schematic diagram illustrating an exemplary mode selection device according to some embodiments of the present disclosure.

In some embodiments, a user may select a first push mode or a second push mode on the mode selection device, as shown in FIG. 38. A processor may automatically adjust a state of one or more pushing handles based on the first push mode or the second push mode selected by the user, such that the state of the one or more pushing handles may match the specific push mode selected by the user. In this way, the user does not need to manually adjust the state of the one or more pushing handles, and automatic switching between the first push mode, the second push mode, and the state of the one or more pushing handles can be realized.

In some embodiments of the present disclosure, the processor may determine the mode executed by the electric mobility apparatus in conjunction with usage information the electric mobility apparatus. For example, the processor may obtain the usage information of the electric mobility apparatus. In response to determining that the usage information of the electric mobility apparatus characterizes that the electric mobility apparatus is not loaded, the processor may determine that the mode executed by the electric mobility apparatus is the first push mode.

The usage information may characterize load information of the electric mobility apparatus. In other words, the usage information of the electric mobility apparatus may be used to characterize whether the electric mobility apparatus is loaded, such as whether the electric mobility apparatus is ridden by a person or whether an item is placed on the electric mobility apparatus. In this way, in response to determining that the electric mobility apparatus is not loaded, the electric mobility apparatus may be automatically switched to the first push mode.

In some embodiments, the processor may obtain the usage information in various ways. For example, the processor may obtain the usage information based on a load sensor. As another example, the processor may directly confirm that the electric mobility apparatus is not loaded in response to determining that the electric mobility apparatus is in the folded state.

FIG. 39 is a schematic diagram illustrating an exemplary architecture of a control system for an electric mobility apparatus according to some embodiments of the present disclosure.

As shown in FIG. 39, a control system 3900 may include an information acquisition device 3901, a processing device 3902, and a control device 3903. The information acquisition device 3901 may be connected with the processing device 3902. The processing device 3902 (e.g., a processor) may be connected with the control device 3903.

For example, the information acquisition device 3901 may be configured to obtain force information. The force information may be used to instruct the electric mobility apparatus to move. An input force characterizes at least one of a force direction or a force magnitude. The processing device 3902 may be configured to determine one or more control commands for the electric mobility apparatus based on the force information. The one or more control commands may include at least one of a control command instructing a movement direction or a control command instructing a movement velocity. The control device 3903 may be configured to control the electric mobility apparatus to move using the one or more control commands.

In some embodiments, the electric mobility apparatus may include a push device. The information acquisition device 701 may include a torque sensor. The torque sensor may be disposed on the push device.

In some embodiments, one end of the torque sensor may be connected to the electric mobility apparatus, and the other end of the torque sensor may be connected to the push device.

In some embodiments, one or more force sensing tabs may be attached to middle hollow portions of two ends of the torque sensor, respectively. The one or more force sensing tabs may be one set of force sensing tabs provided in forward and backward directions, or two sets of force sensing tabs provided in forward and backward directions and in leftward and rightward directions. By adjusting an angle between detection directions of the force sensing tabs and a deployment direction of the torque sensor, it is ensured that the sensing forces of the force sensing tabs are kept horizontal in the forward and backward directions, thereby eliminating the interference of a component force of a tilt external force.

In some embodiments, the push device may internally include a first limiting member, a limiting pin, and a locking and unlocking mechanism. The first limiting member and the limiting pin may be connected through a rotating shaft. A locking tooth block of the first limiting member and a locking tooth block of the limiting pin may be limited through a locking tooth block of the locking and unlocking mechanism.

In some embodiments, the push device may include the first limiting member, the limiting pin, and the locking and unlocking mechanism. The locking tooth blocks of the first limiting member and the limiting pin may be meshed and limited with each other through a locking tooth sleeve of the locking and unlocking mechanism such that the push device can only rotate in a range of 0°-270°, wherein mechanical limitation is implemented when rotating to 270°, and resetting to 0° needs to rotate back through the original way, thereby avoiding 360° rotation of the push device.

In some embodiments, the locking and unlocking mechanism and the first limiting member may include an extended tooth A, respectively. By setting a relatively long dimension to the extended tooth A, when the two extended teeth A rotate together, the two extended teeth A may interfere with each other, preventing the push device from continuing to rotate.

In some embodiments, the locking tooth block of the locking and unlocking mechanism may be disengaged from the locking tooth block of the first limiting member. The information acquisition device 3901 may be further configured to receive a state adjustment operation for one or more pushing handles.

In other words, when the locking tooth block of the locking and unlocking mechanism is disengaged from the locking tooth block of the first limiting member, the push device may rotate through the rotating shaft, and the user may adjust the state of the push device (e.g., the one or more pushing handles). More descriptions regarding the first limiting member, the limiting pin, and the locking and unlocking mechanism may be found in the related descriptions of FIGS. 21-23.

In some embodiments, the push device may include an indication module. The indication module may be configured to indicate a mode executed by the electric mobility apparatus.

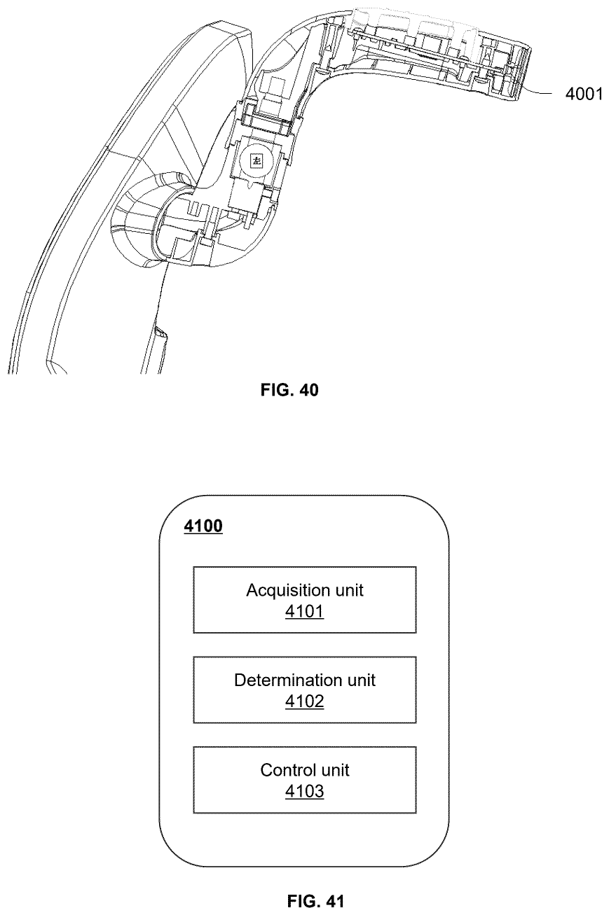

FIG. 40 is a schematic diagram illustrating an exemplary indication module according to some embodiments of the present disclosure. FIG. 41 is a schematic diagram illustrating an exemplary structure of a control device for an electric mobility apparatus according to some embodiments of the present disclosure.

In some embodiments, as shown in FIG. 40, a push device may include an indication module 4001. The indication module 4001 may include a status light and a status light guide post. The status light may include large-angle straw hat lamp beads of 120°, an integral light guide post, and a light shield. The status light may present a different color when a mode executed by the electric mobility apparatus is switched.

In some embodiments, referring to FIG. 41, a control device 4100 for an electric mobility apparatus may include: an acquisition unit 4101, a determination unit 4102, and a control unit 4103.

The acquisition unit 4101 may be configured to obtain force information. The force information may be used to instruct the electric mobility apparatus to move. An input force characterizes at least one of a force direction or a force magnitude.

The determination unit 4102 may be configured to determine one or more control commands for the electric mobility apparatus based on the force information. The one or more control commands may include at least one of a control command instructing a movement direction or a control command instructing a movement velocity.

The control unit 4103 may be configured to control the electric mobility apparatus to move based on the one or more control commands.

In some embodiments, the electric mobility apparatus may include a push device. The acquisition unit 4101 may be configured to obtain the force information of the push device.

In some embodiments, the acquisition unit 4101 may be configured to: collect a first torque acting on a first position of the push device, and collect a second torque acting on a second position of the push device.

In some embodiments, the push device may include a first pushing handle and a second pushing handle. The first pushing handle and the second pushing handle may be disposed on both sides of the electric mobility apparatus, respectively. The acquisition unit 4101 may be configured to: collect the first torque acting on the first pushing handle, and collect the second torque acting on the second pushing handle.

In some embodiments, the push device may include a third pushing handle. The acquisition unit 4101 may be configured to: collect the first torque acting on a left side region of the third pushing handle, and collect the second torque acting on a right side region of the third pushing handle.

In some embodiments, the force information may include the first torque and the second torque. The determination unit 4102 may be configured to determine, when a force direction characterized by the first torque and a force direction characterized by the second torque are the same, and a force magnitude characterized by the first torque and a force magnitude characterized by the second torque are the same, a control command instructing the electric mobility apparatus to perform a linear movement.

In some embodiments, the force information may include the first torque and the second torque. The determination unit 4102 may be configured to determine, when the force direction characterized by the first torque and the force direction characterized by the second torque are different, or the force magnitude characterized by the first torque and the force magnitude characterized by the second torque are different, a control command instructing the electric mobility apparatus to perform a steering movement.

In some embodiments, the control unit 4103 may be further configured to control, in response to determining that the detected force magnitude characterized by the force information is not zero, a braking device of the electric mobility apparatus to be opened.

In some embodiments, the control unit 4103 may be further configured to control, in response to determining that the detected force magnitude characterized by the force information is 0, the braking device of the electric mobility apparatus to be closed.

In some embodiments, the determination unit 4102 may be configured to: determine, based on the force information, a first control force for controlling a movement of the electric mobility apparatus in a linear direction and a second control force for controlling a movement of the electric mobility apparatus in a non-linear direction; and determine, based on the first control force and the second control force, one or more control commands for the electric mobility apparatus.

In some embodiments, the determination unit 4102 may be configured to: determine, based on the first control force and the second control force, a first target driving parameter for a first driving device of the electric mobility apparatus and a second target driving parameter for a second driving device of the electric mobility apparatus. The first driving device may be configured to control a left wheel of the electric mobility apparatus, and the second driving device may be configured to control a right wheel of the electric mobility apparatus.

In some embodiments, the determination unit 4102 may be configured to: determine, based on the first control force and the second control force, a target linear velocity and a target angular velocity of the electric mobility apparatus; and determine, based on the target linear velocity and the target angular velocity of the electric mobility apparatus, the first target driving parameter for the first driving device of the electric mobility apparatus and the second target driving parameter for the second driving device of the electric mobility apparatus.

In some embodiments, the control unit 4103 may be further configured to control, in response to determining that the force information does not satisfy a preset condition, the electric mobility apparatus to stop moving. The preset condition refers to a condition indicating a safe movement of the electric mobility apparatus.

In some embodiments, the device 4100 may further include a detection unit configured to: detect the mode executed by the electric mobility apparatus.

The acquisition unit 4101 may be configured to: in response to determining that the mode executed by the electric mobility apparatus is a push mode, obtain the force information of the push device.

In some embodiments, the detection unit may be configured to: receive a mode selection signal; and determine, based on the mode selection signal, the mode executed by the electric mobility apparatus.

In some embodiments, in response to determining that the mode executed by the electric mobility apparatus is the push mode, and the push device includes one or more pushing handles, the determination unit 4102 may be further configured to: receive a state adjustment operation for the one or more pushing handles; in response to determining that the one or more pushing handles are adjusted to a horizontal state based on the state adjustment operation, determine the mode executed by the electric mobility apparatus as a first push mode; the horizontal state characterizing that the one or more pushing handles are parallel to a backrest of the electric mobility apparatus.

In some embodiments, the determination unit 4102 may be further configured to determine, in response to determining that the one or more pushing handles are adjusted to an unfolded state based on the state adjustment operation, the mode executed by the electric mobility apparatus as a second push mode; the unfolded state characterizing that the one or more pushing handles are not parallel to the backrest of the electric mobility apparatus.

In some embodiments, in response to determining that the mode executed by the electric mobility apparatus is the push mode, and the push device includes the one or more pushing handles, the determination unit 4102 may be further configured to: receive a mode refinement signal in the push mode; in response to determining that the mode refinement signal indicates that the mode executed by the electric mobility apparatus is the first push mode, adjust the one or more pushing handles to the horizontal state; the horizontal state characterizing that the one or more pushing handles are parallel to the backrest of the electric mobility apparatus; in response to determining that the mode refinement signal indicates that the mode executed by the electric mobility apparatus is the second push mode, adjust the one or more pushing handles to the unfolded state; the unfolded state characterizing that the one or more pushing handles are not parallel to the backrest of the electric mobility apparatus.

In some embodiments, the determination unit 4102 may be further configured to: obtain usage information of the electric mobility apparatus, the usage information characterizing load information of the electric mobility apparatus; in response to determining that the usage information of the electric mobility apparatus characterizes that the electric mobility apparatus is not loaded, determine that the mode executed by the electric mobility apparatus is the first push mode.

In the actual usage of the electric mobility apparatus in a riding mode, after the user operates an operation device of the electric mobility apparatus, the electric mobility apparatus may have the problems of too fast startup velocity and heavy sense of abruptness in the movement, which affects the user experience.

Some embodiments of the present disclosure further provide another control method for an electric mobility apparatus, enabling the user to have a good user experience in the riding mode.

In some embodiments, a current operation mode may include the riding mode. In some embodiments, the processor may obtain input information of the electric mobility apparatus in the current operation mode, including: obtaining operation information input by the user to the operation device of the electric mobility apparatus; determining, based on the input information, one or more control commands for the electric mobility apparatus.

The operation information refers to information input by the user that is related to an operation. For example, the operation information may include switching the operation mode, accelerating the movement of the electric mobility apparatus, etc. In the riding mode, the user who inputs the operation information to the electric mobility apparatus may be a first user. It should be noted that in some special scenarios of the riding mode, the operation information may be input to the electric mobility apparatus by a second user. For example, if the first user is a patient with disabilities in hands and feet, the operation information may be input to the electric mobility apparatus by the second user.

In some embodiments, the processor may obtain a current velocity parameter of the electric mobility apparatus; determine a current target acceleration based on the operation information and the current velocity parameter; and determine the one or more control commands for the electric mobility apparatus based on the current target acceleration.

In some embodiments, the processor may determine various parameters (e.g., a velocity parameter, an acceleration parameter, etc.) through a plurality of computation cycles. Parameters that are determined and used in the current computation cycle are referred to as current parameters. For example, a velocity parameter in the current computation cycle may be referred to as the current velocity parameter, and a target acceleration determined in the current computation cycle may be referred to as the current target acceleration.

In some embodiments, the processor may obtain the current velocity parameter of the electric mobility apparatus in various ways. For example, the processor may obtain the current velocity parameter by reading a driving parameter for one or more driving devices.

In some embodiments, the processor may determine the current target acceleration in various ways based on the operation information and the current velocity parameter. For example, the processor may determine the current target acceleration through a preset algorithm. Merely by way of example, the preset algorithm is a formula for determining the current target acceleration based on the operation information and the current velocity parameter.

In some embodiments, the processor may determine the one or more control commands for the electric mobility apparatus in various ways based on the current target acceleration. For example, the one or more control commands may be adjusting the current velocity parameter until the acceleration reaches the current target acceleration.

In some embodiments, the target acceleration may include a target linear acceleration and a target angular acceleration. In some embodiments, the processor may determine the current target acceleration based on the operation information and the current velocity parameter, including: determining a current target linear acceleration based on the operation information and a parameter related to a linear velocity in the current velocity parameter; and determining a current target angular acceleration based on the operation information and a parameter related to an angular velocity in the current velocity parameter.

In some embodiments, the operation information may include coordinate information of the operation device. In some embodiments, the processor may determine the current target acceleration based on the operation information and the current velocity parameter, including: determining a target linear velocity and a target angular velocity of the electric mobility apparatus based on the coordinate information of the operation device; and determining the current target acceleration based on the target linear velocity, the target angular velocity, and the current velocity parameter.

In some embodiments, the current velocity parameter may include a current acceleration. In some embodiments, the processor may determine the current target acceleration based on the operation information and the current velocity parameter, including: determining a current maximum acceleration based on the operation information and the current velocity parameter; and determining the current target acceleration based on a relationship between a magnitude of the current maximum acceleration and a magnitude of the current acceleration.

In some embodiments, the processor may determine the current target acceleration based on the relationship between the magnitude of the current maximum acceleration and the magnitude of the current acceleration, including: in response to determining that the current maximum acceleration is greater than the current acceleration, determining that the current target acceleration is greater than the current acceleration; in response to determining that the current maximum acceleration is smaller than the current acceleration, determining that the current target acceleration is smaller than the current acceleration; and in response to determining that the current maximum acceleration is equal to the current acceleration, determining that the current target acceleration is equal to the current acceleration.

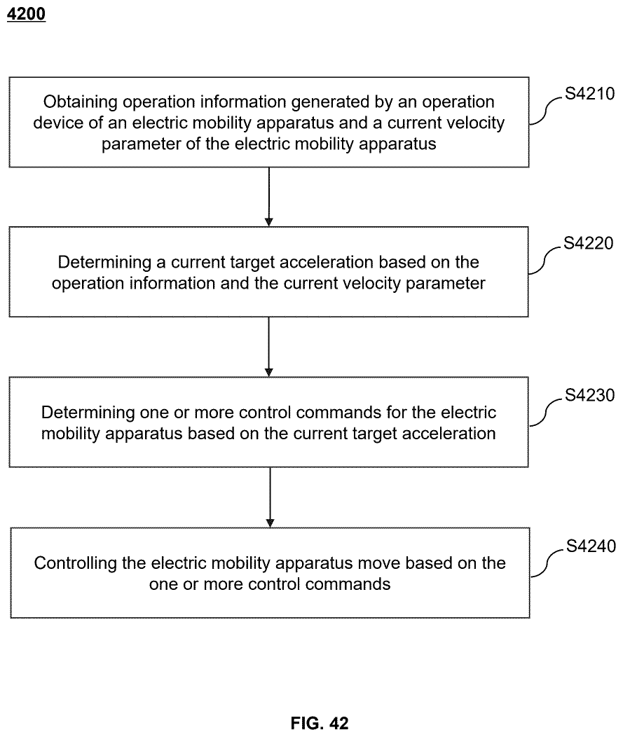

More descriptions may be found in the related descriptions of FIG. 42.

In some embodiments, the processor may determine the one or more control commands for the electric mobility apparatus based on the current target acceleration, including: determining a current target velocity parameter of the electric mobility apparatus based on the current target acceleration; and determining a target driving parameter for one or more driving devices of the electric mobility apparatus based on the current target velocity parameter of the electric mobility apparatus.

In some embodiments, the processor may obtain the current velocity parameter of the electric mobility apparatus, including: determining a current target velocity parameter of the electric mobility apparatus in a previous computation cycle as the current velocity parameter of the electric mobility apparatus in a current computation cycle.

Some embodiments of the present disclosure provide another control method for an electric mobility apparatus. The control method may include first obtaining operation information generated by an operation device of the electric mobility apparatus; obtaining a current velocity parameter of the electric mobility apparatus, the operation information characterizing an operation direction and an operation velocity; determining a current target acceleration based on the operation information and the current velocity parameter; and determining one or more control commands for the electric mobility apparatus based on the current target acceleration. The one or more control commands may include at least one of a control command instructing a movement direction or a control command instructing a movement velocity. The electric mobility apparatus may be controlled to move based on the one or more control commands.

FIG. 42 is a flowchart illustrating an exemplary control process for an electric mobility apparatus according to some embodiments of the present disclosure. As shown in FIG. 42, a process 4200 may include the following operations S4210-S4240. In some embodiments, the process 4200 may be implemented by a processor.

In S4210, operation information generated by an operation device of the electric mobility apparatus may be obtained, and a current velocity parameter of the electric mobility apparatus may be obtained.

The operation device of the electric mobility apparatus may be understood as a device for a rider of the electric mobility apparatus to control a movement of the electric mobility apparatus. For example, the operation device may be an operating lever, a rocker, a remote control, or the like, which is not limited in the embodiments of the present disclosure.

In some embodiments of the present disclosure, the operation information generated by the operation device may be understood as a command generated by the rider of the electric mobility apparatus operating the operation device. In other words, the operation information generated by the operation device may characterize an intention of the rider of the electric mobility apparatus to operate the electric mobility apparatus.

In some embodiments, the operation information may characterize an operation direction and an operation velocity. For example, if the operation device is the operating lever, the rider of the electric mobility apparatus may generate the operation information by moving the operating lever. A movement direction of the operating lever may characterize the operation direction, and a movement distance of the operating lever may characterize the operation velocity.

In some embodiments, the operation information may also characterize other operations of the user, such as switching an operation mode.

The current velocity parameter of the electric mobility apparatus may be understood as a parameter characterizing a current movement state of the electric mobility apparatus. For example, the current velocity parameter may include a current velocity, a current acceleration, a current jerk acceleration, or the like, which is not limited in the embodiments of the present disclosure.

The current mobile state of the electric mobility apparatus refers to a movement state corresponding to a moment at which the operation information is generated by the operation device of the electric mobility apparatus. When the operation information is generated by the operation device of the electric mobility apparatus at different moments, the current movement state of the electric mobility apparatus may be different, and the current velocity parameter of the electric mobility apparatus may also be different. In some embodiments, the control of the electric mobility apparatus may be divided into a plurality of computation cycles. In this case, the corresponding moment may be understood to be the same computation cycle, i.e., the operation information generated by the operation device in the current computation cycle may be obtained and the current velocity parameter of the electric mobility apparatus in the current computation cycle may be obtained.

Some embodiments of the present disclosure are not limited as to the manner of obtaining the operation information and the current velocity parameter, and the processor may obtain the operation information and the current velocity parameter through sensors disposed on the electric mobility apparatus, or by any means.

In S4220, a current target acceleration may be determined based on the operation information and the current velocity parameter.

The current target acceleration may be understood as an acceleration that is expected to be achieved by the electric mobility apparatus under the operation information and the current velocity parameter. Similarly, when the operation information is generated by the operation device of the electric mobility apparatus at different moments, the current movement state of the electric mobility apparatus may be different, the current velocity parameter of the electric mobility apparatus may be different, and the current target acceleration may also be different. For example, for the operation information and the current velocity parameter in the current computation cycle, the current target acceleration may be an acceleration expected to be reached by the electric mobility apparatus in the current computation cycle.

In some embodiments of the present disclosure, since the operation information may instruct the electric mobility apparatus to move, combining the operation information and the current velocity parameter, the processor may determine the current target acceleration that corresponds to the current speed parameter and conforms to the operation intention characterized by the operation information.

In S4230, one or more control commands for the electric mobility apparatus may be determined based on the current target acceleration.

The one or more control commands may include a command for controlling one or more driving devices of the electric mobility apparatus. For example, if the one or more driving devices is a motor, the one or more control commands may include a command for controlling the motor.

In some embodiments of the present disclosure, the one or more control commands may include at least one of a control command instructing a movement direction or a control command instructing a movement velocity. That is, the processor may determine, based on the current target acceleration, at least one of the control command instructing the movement direction or the control command instructing the movement velocity to control the electric mobility apparatus to move at the current target acceleration.

In S4240, the electric mobility apparatus may be controlled to move based on the one or more control commands.

After the one or more control commands for the electric mobility apparatus are determined, the processor may control the electric mobility apparatus to move based on at least one of the movement direction or the movement velocity indicated by the control command. For example, if the one or more driving device is the motor, the motor may be controlled based on the control command to drive the electric mobility apparatus to move at the current target acceleration.

In some embodiments of the present disclosure, the processor may determine the current target acceleration by combining the operation information and the current velocity parameter of the electric mobility apparatus, and determine the one or more control commands based on the current target acceleration to control the electric mobility apparatus to move. In this way, in response to the operation information generated by the operation device, different current target accelerations may be configured under different current velocity parameters, and the acceleration may match the velocity during the movement of the electric mobility apparatus, thereby achieving smooth control, and enhancing the user experience.

In some embodiments, the control of the electric mobility apparatus may be divided into a plurality of computation cycles. In this case, the processor may obtain the operation information generated by the operation device of the electric mobility apparatus in the current computation cycle, obtain the current velocity parameter of the electric mobility apparatus in the current computation cycle, determine, based on the operation information and the current velocity parameter in the current computation cycle, the current target acceleration in the current computation cycle, determine the one or more control commands for the electric mobility apparatus according to the current target acceleration in each computation cycle, and control the electric mobility apparatus to move based on the one or more control commands.

In some embodiments, the current target acceleration may be specifically categorized into a current target linear acceleration and a current target angular acceleration. In some embodiments, the processor may determine the current target linear acceleration based on the operation information and a velocity parameter related to a linear velocity in the current velocity parameter, and determine the current target angular acceleration based on the operation information and a velocity parameter related to an angular velocity in the current velocity parameter.

That is to say, the current velocity parameter may include the velocity parameter related to the linear velocity and the velocity parameter related to the angular velocity. The processor may determine the current target linear acceleration and the current target angular acceleration by decoupling the linear velocity and the velocity parameter, so as to subsequently control the direction and the velocity of the electric mobility apparatus.

In some embodiments, the operation information may be characterized by coordinate information of the operation device. For example, if the operation device is an operating lever, the user may adjust a position of the operating lever, and the operating lever may generate the operation information. The processor may establish a coordinate system using an initial position of the operating lever as the origin. The current position of the operating lever may be characterized in the form of the coordinate information.

In this case, the processor may determine a target linear velocity and a target angular velocity based on the coordinate information of the operation device, and determine the current target acceleration based on the target linear velocity, the target angular velocity, and the current velocity parameter. In other words, the processor may decouple the linear velocity and the angular velocity by converting the coordinate information of the operation device into the target linear velocity and the target angular velocity, so as to subsequently control the direction and the velocity of the electric mobility apparatus.

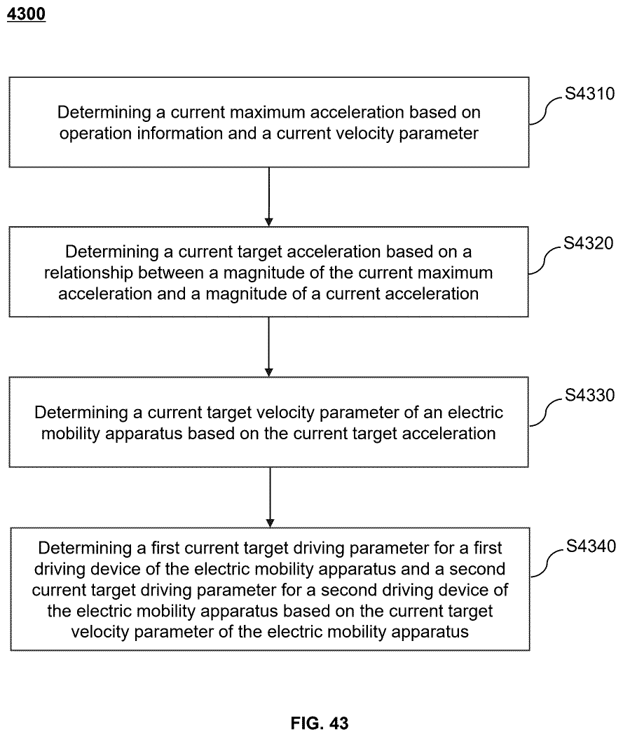

FIG. 43 is a flowchart illustrating an exemplary process for determining a driving parameter according to some embodiments of the present disclosure. As shown in FIG. 43, a process 4300 may include the following operations S4310-S4330. In some embodiments, the process 4300 may be implemented by a processor.

Referring to FIG. 43, in some embodiments of the present disclosure, an obtained current velocity parameter may include a current acceleration. In S4310, a current maximum acceleration may be determined based on operation information and a current velocity parameter. In S4320, a current target acceleration may be determined based on a relationship between a magnitude of the current maximum acceleration and a magnitude of a current acceleration.

In some embodiments of the present disclosure, the current target acceleration in different computation cycles may be related to the relationship between the magnitude of the current maximum acceleration and the magnitude of the current acceleration. The current maximum acceleration may be understood as a maximum acceleration that may be achieved by the electric mobility apparatus under the operation information and the current velocity parameter. By determining the current target acceleration by combining the current maximum acceleration, the current target acceleration may match the current maximum acceleration, thereby enhancing the mobility efficiency of the electric mobility apparatus, and ensuring the movement smoothness of the electric mobility apparatus.

For example, in response to determining that the current maximum acceleration is greater than the current acceleration, the processor may determine that the current target acceleration is greater than the current acceleration. In response to determining that the current maximum acceleration is less than the current acceleration, the processor may determine that the current target acceleration is less than the current acceleration. In response to determining that the current maximum acceleration is equal to the current acceleration, the processor may determine that the current target acceleration is equal to the current acceleration.

In some embodiments of the present disclosure, the current target acceleration corresponding to the relationship between the magnitude of the current maximum acceleration and the magnitude of the current acceleration may be determined, such that the current target acceleration under a different computation cycle may match the operation information and the current velocity parameter under the computation cycle, thereby realizing the real-time change of the current target acceleration.

In S4330, a current target velocity parameter of the electric mobility apparatus may be determined based on the current target acceleration. In S4340, a first current target driving parameter for a first driving device of the electric mobility apparatus and a second current target driving parameter for a second driving device of the electric mobility apparatus may be determined based on the current target velocity parameter of the electric mobility apparatus.

In some embodiments, the first driving device may be configured to control a left wheel of the electric mobility apparatus, and the second driving device may be configured to control a right wheel of the electric mobility apparatus. More descriptions regarding the driving device and the driving parameter may be found in the present disclosure above.

In some embodiments of the present disclosure, for each computation cycle, the processor may determine, through the current target acceleration in the current computation cycle, the current target velocity parameter that the electric mobility apparatus is required to achieve in the current computation cycle. In this way, in combination with the current target velocity parameter, the current target driving parameter for one or more driving devices of the electric mobility apparatus in the current computing cycle may be determined, and the one or more driving devices may drive the left wheel and the right wheel of the electric mobility apparatus based on the current target driving parameter, such that the electric mobility apparatus may move at the current target acceleration.

In some embodiments, the processor may determine the current target velocity parameter of the electric mobility apparatus in a previous computation cycle as the current velocity parameter of the electric mobility apparatus in a current computation cycle. That is, for the plurality of consecutive computation cycles, the current target velocity parameter of the electric mobility apparatus in the previous computation cycle may be determined as the current velocity parameter of the electric mobility apparatus in the current computation cycle, thereby realizing continuous control in multiple computation cycles, and improving the consistency of the mobility control of the electric mobility apparatus.

In some embodiments, for the current computation cycle, the processor may obtain coordinate information of an operation device and obtain the current target velocity parameter of the electric mobility apparatus in the previous computation cycle, and determine the current target velocity parameter of the electric mobility apparatus in the previous computation cycle as the current velocity parameter in the current computation cycle. The current velocity parameter may include a current linear velocity, a current angular velocity, a current linear acceleration, a current angular acceleration, a current linear acceleration, a current angular acceleration, a current linear jerk acceleration, and a current angular jerk acceleration.

Since the linear velocity and the angular velocity are decoupled and controlled separately in some embodiments of the present disclosure, the algorithmic logic for determining the current target linear acceleration and the current target angular acceleration may be similar.

The current velocity (the current linear velocity or the current angular velocity) is denoted as v_c, the current acceleration (the current linear acceleration or the current angular acceleration) is denoted as a_c, and the current jerk acceleration (the current linear jerk acceleration or the current angular jerk acceleration) is denoted as j. The processor may determine the target velocity (the target linear velocity or the target angular velocity) based on the coordinate information of the operation device, the target velocity being denoted as v_s.

The processor may calculate a difference v_e between the target velocity v_s and the current velocity v_c, and determine the current maximum acceleration a based on the difference v_e between the target velocity and the current velocity through an equation as a=\sqrt{2*j*v_e}.

Then the processor may determine the current target acceleration based on the relationship between the magnitude of the current maximum acceleration and the magnitude of the current acceleration. If a_c+j<a, the current target acceleration a_c1=a_c+j; if a_c−j>a, the current target acceleration a_c1=a_c−j; otherwise, the current target acceleration a_c1=a.

That is, if the current maximum acceleration is greater than the current acceleration, and the difference between the current maximum acceleration and the current acceleration is greater than a preset value (i.e., the current jerk acceleration), the processor may determine the current target acceleration as a sum of the current acceleration and the preset value. If the current maximum acceleration is less than the current acceleration and the difference between the current acceleration and the current maximum acceleration is greater than the preset value (i.e., the current jerk acceleration), the processor may determine the current target acceleration as the difference between the current acceleration and the preset value. Otherwise, the processor may determine the current target acceleration as the current maximum acceleration. Then the processor may determine the current target velocity parameter v_c1=v_c+a_c1 based on the current target acceleration.

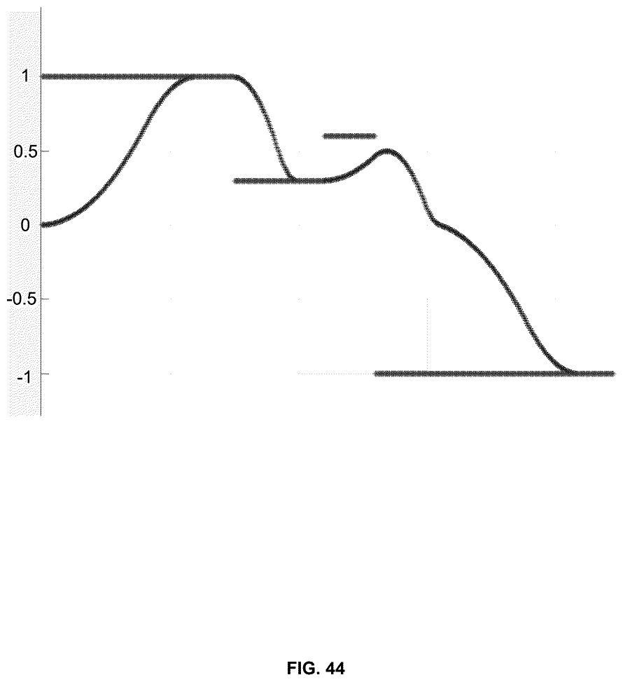

FIG. 44 is a schematic diagram illustrating an exemplary velocity change according to some embodiments of the present disclosure.

As shown in FIG. 44, the processor may determine a current target acceleration corresponding to operation information and a current velocity parameter under a different computation cycle, and control an electric mobility apparatus to move at a variable acceleration, so as to achieve the effect of S-shaped acceleration and deceleration. The velocity change of the electric mobility apparatus may be smooth, and the sense of abruptness may be reduced to a certain extent.

Referring to a specific scenario for illustration, if a rider of the electric mobility apparatus controls the electric mobility apparatus to move, the processor may obtain operation information generated by an operation device of the electric mobility apparatus and the current velocity parameter of the electric mobility apparatus, determine a current target acceleration corresponding to a moment at which the operation information is generated by the operation device of the electric mobility apparatus based on the operation information and the current velocity parameter, and determine one or more control commands based on the current target acceleration to control the electric mobility apparatus to move. In this way, for the operation information triggered by the rider of the electric mobility apparatus at different moments, the current target acceleration may be determined based on the current velocity parameter at the corresponding moment, such that the target acceleration of the electric mobility apparatus for movement in different movement states may match the current velocity parameter, thereby realizing the effect of intelligent turning acceleration and deceleration, and ensuring the smooth movement of the electric mobility apparatus.

In some embodiments of the present disclosure, the processor may be configured to control a braking device of the electric mobility apparatus. More descriptions regarding the braking device may be found in the present disclosure above.

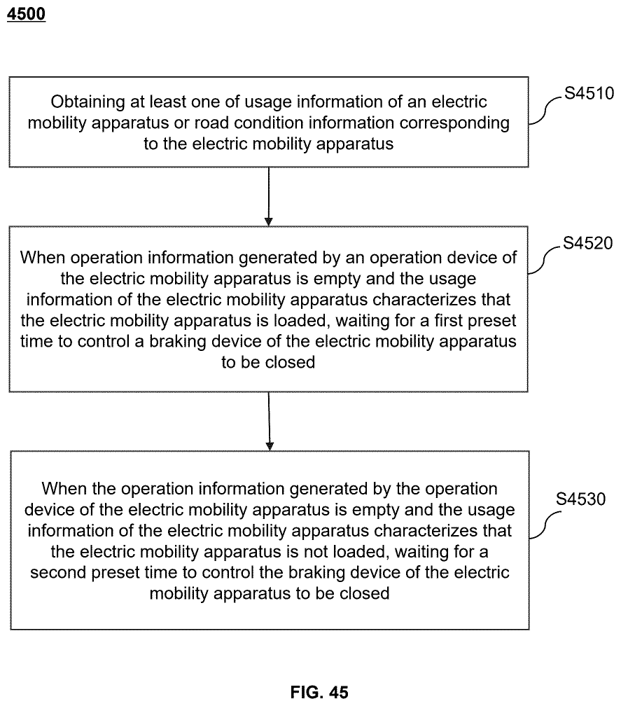

FIG. 45 is a flowchart illustrating an exemplary process for controlling a braking device according to some embodiments of the present disclosure. As shown in FIG. 45, a process 4500 may include the following operations S4510-S4530. In some embodiments, the process 4500 may be implemented by a processor.

For example, referring to FIG. 45, in S4510, at least one of usage information of an electric mobility apparatus or road condition information corresponding to the electric mobility apparatus may be obtained, and a control strategy for a braking device of the electric mobility apparatus may be determined based on at least one of the usage information of the electric mobility apparatus or the road condition information corresponding to the electric mobility apparatus.

In some embodiments, the usage information of the electric mobility apparatus may include load information of the electric mobility apparatus. In other words, the usage information of the electric mobility apparatus may be used to indicate whether there is a load on the electric mobility apparatus, such as whether a person rides on the electric mobility apparatus or whether an item is placed on the electric mobility apparatus.

The road condition information corresponding to the electric mobility apparatus may include a slope condition of a road on which the electric mobility apparatus is located. For example, the road condition information corresponding to the electric mobility apparatus may include slope information.

In some embodiments, the usage information of the electric mobility apparatus may be obtained by a load sensor, and the road condition information corresponding to the electric mobility apparatus may be obtained by a slope sensor.

In some embodiments of the present disclosure, by combining at least one of the usage information or the road condition information, opening and closing of the braking device can be accurately controlled based on the usage state and usage use scenario of the electric mobility apparatus, thereby avoiding the unsafe movement of the electric mobility apparatus.

In some embodiments, when the road condition information corresponding to the electric mobility apparatus characterizes that the slope of the road condition in which the electric mobility apparatus is located satisfies a preset condition, and the driving parameter for the first driving device or the second driving device of the electric mobility apparatus is not 0, the processor may control the braking device of the electric mobility apparatus to be closed.

In some embodiments, the preset condition may include that the slope of the road condition in which the electric mobility apparatus is located is greater than a preset angle. In this way, if the electric mobility apparatus is located in a road condition with a large slope and the one or more driving devices drive the electric mobility apparatus to move, the processor may control the braking device to be closed, causing the electric mobility apparatus to stop moving, and avoiding “skidding” and other unsafe movement under the road condition with a large slope.

In some embodiments, the slope sensor may be disposed in the electric mobility apparatus. The slope sensor may be configured to collect the road condition information (i.e., the slope) corresponding to the electric mobility apparatus. The one or more driving devices of the electric mobility apparatus may be a motor. When the rider of the electric mobility apparatus controls the electric mobility apparatus to move, the processor may obtain the road condition information corresponding to the electric mobility apparatus through the slope sensor, and obtain a rotational velocity of the motor of the electric mobility apparatus. If the slope of the road condition in which the electric mobility apparatus is located is greater than the preset angle, and a rotational velocity of a first motor or a second motor of the electric mobility apparatus is not 0, it indicates that the electric mobility apparatus is in the road condition with a large slope, such as an uphill section or a downhill section, and that the electric mobility apparatus has a certain moving velocity. In this case, the processor may control the braking device of the electric mobility apparatus to be closed, such as controlling an electromagnetic brake of the electric mobility apparatus to be closed, to achieve the purpose of controlling the electric mobility apparatus to stop. In this way, slope slipping caused by lack of uphill power and slope rushing caused by too fast downhill velocity can be avoided, thereby improving the mobility safety of the electric mobility apparatus.

In some embodiments, when the usage information of the electric mobility apparatus characterizes that the electric mobility apparatus is not loaded and the operation information generated by the operation device of the electric mobility apparatus is not empty, the processor may control the braking device of the electric mobility apparatus to be closed.

That is to say, if the user does not ride the electric mobility apparatus but the electric mobility apparatus is touched by mistake, the processor may control the braking device to be closed, such that the electric mobility apparatus does not move, and the unsafe movement such as the movement when no one rides the electric mobility apparatus can be avoided.

In some embodiments, when the usage information of the electric mobility apparatus characterizes that the electric mobility apparatus is loaded and the operation information generated by the operation device of the electric mobility apparatus is not empty, the processor may control the braking device of the electric mobility apparatus to be opened.

That is to say, when the user rides the electric mobility apparatus and controls the operation device, the processor may control the braking device to be opened automatically without manual operation of the user, realizing the smooth operation experience.

In the control process for the electric mobility apparatus, when the operation information generated by the operation device of the electric mobility apparatus is empty, the processor may control the braking device of the electric mobility apparatus to be closed.

That is to say, when the user rides the electric mobility apparatus and does not control the operation device, the processor may control the braking device to be closed automatically, avoiding that the braking device stays open, reducing power consumption, and improving the duration of the electric mobility apparatus.

In some embodiments, referring to FIG. 45, in S4520, when the operation information generated by the operation device of the electric mobility apparatus is empty and the usage information of the electric mobility apparatus characterizes that the electric mobility apparatus is loaded, the processor may wait for a first preset time to control the braking device of the electric mobility apparatus to be closed.

In S4530, when the operation information generated by the operation device of the electric mobility apparatus is empty and the usage information of the electric mobility apparatus characterizes that the electric mobility apparatus is not loaded, the processor may wait for a second preset time to control the braking device of the electric mobility apparatus to be closed. The first preset time may be greater than the second preset time.

That is, if the user does not control the operation device, the processor may control the braking device of the electric mobility apparatus to be closed at different time intervals based on whether the electric mobility apparatus is loaded. If the user does not control the operation device but does not leave the electric mobility apparatus, the user may have an intention to control the operation device again within a short time period, and thus the processor may wait for a relatively long time interval before controlling the braking device to be closed. If the user does not control the operation device and leaves the electric mobility apparatus, the user may not control the operation device again within a short time period, and thus the processor may wait for a relatively short time interval before controlling the braking device to be closed.

In this way, frequent opening and closing of the braking device can be avoided, improving the service life of the braking device, and reducing the noise interference due to the opening and closing of the braking device.

FIG. 46 is a schematic diagram illustrating an exemplary structure of a control device for an electric mobility apparatus according to some embodiments of the present disclosure.

As shown in FIG. 46, a control device 4600 may include: an acquisition module 4601, a first determination module 4602, a second determination module 4603, and a control module 4604.

The acquisition module 4601 may be configured to obtain operation information generated by an operation device of an electric mobility apparatus; and obtain a current velocity parameter of the electric mobility apparatus; the operation information characterizing an operation direction and an operation velocity.

The first determination module 4602 may be configured to determine a current target acceleration based on the operation information and the current velocity parameter.

The second determination module 4603 may be configured to determine one or more control commands for the electric mobility apparatus based on the current target acceleration. The one or more control commands may include at least one of a control command instructing a movement direction or a control command instructing a movement velocity.

The control module 4604 may be configured to control the electric mobility apparatus to move based on the one or more control commands.

In some embodiments, the first determination module 4602 may be configured to: determine, based on the operation information and a velocity parameter related to a linear velocity in the current velocity parameter, a current target linear acceleration; and determine, based on the operation information and a velocity parameter related to an angular velocity in the current velocity parameter, a current target angular acceleration.

In some embodiments, the operation information may be characterized by coordinate information of an operation device. The first determination module 4602 may be configured to: determine a target linear velocity and a target angular velocity based on the coordinate information of the operation device; and determine the current target acceleration based on the target linear velocity, the target angular velocity, and the current velocity parameter.

In some embodiments, the current velocity parameter may include a current acceleration. The first determination module 4602 may be configured to: determine a current maximum acceleration based on the operation information and the current velocity parameter; and determine the current target acceleration based on a relationship between a magnitude of the current maximum acceleration and a magnitude of the current acceleration.

In some embodiments, the first determination module 4602 may be configured to: in response to determining that the current maximum acceleration is greater than the current acceleration, determine that the current target acceleration is greater than the current acceleration; in response to determining that the current maximum acceleration is less than the current acceleration, determine that the current target acceleration is less than the current acceleration; and in response to determining that the current maximum acceleration is equal to the current acceleration, determine that the current target acceleration is equal to the current acceleration.

In some embodiments, the second determination module 4603 may be configured to: determine, based on the current target acceleration, a current target velocity parameter of the electric mobility apparatus; determine, based on the current target velocity parameter of the electric mobility apparatus, a first current target driving parameter for a first driving device of the electric mobility apparatus and a second current target driving parameter for a second driving device of the electric mobility apparatus. The first driving device may be configured to control a left wheel of the electric mobility apparatus, and the second driving device may be configured to control a right wheel of the electric mobility apparatus.

In some embodiments, the acquisition module 4601 may be configured to: determine a current target velocity parameter of the electric mobility apparatus in a previous computation cycle as the current velocity parameter of the electric mobility apparatus.

In some embodiments, the control device 4600 may further include a third determination module. The third determination module may be configured to: obtain at least one of usage information of the electric mobility apparatus or road condition information corresponding to the electric mobility apparatus; the usage information characterizing load information of the electric mobility apparatus; and determine a control strategy for a braking device of the electric mobility apparatus based on at least one of the usage information of the electric mobility apparatus or the road condition information corresponding to the electric mobility apparatus.

In some embodiments, the third determination module may be configured to: in response to determining that the road condition information corresponding to the electric mobility apparatus characterizes that a slope of a road condition in which the electric mobility apparatus is located satisfies a preset condition, and a driving parameter for the first driving device or the second driving device of the electric mobility apparatus is not 0, control the braking device of the electric mobility apparatus to be closed.

In some embodiments, the third determination module may be configured to: in response to determining that the usage information of the electric mobility apparatus characterizes that the electric mobility apparatus is not loaded and the operation information generated by the operation device of the electric mobility apparatus is not empty, control the braking device of the electric mobility apparatus to be closed.

In some embodiments, the third determination module may be configured to: in response to determining that the usage information of the electric mobility apparatus characterizes that the electric mobility apparatus is loaded and the operation information generated by the operation device of the electric mobility apparatus is not empty, control the braking device of the electric mobility apparatus to be opened.

In some embodiments, the third determination module may be further configured to: in response to determining that the operation information generated by the operation device of the electric mobility apparatus is empty, control the braking device of the electric mobility apparatus to be closed.

In some embodiments, the third determination module may be configured to: in response to determining that the operation information generated by the operation device of the electric mobility apparatus is empty and the usage information of the electric mobility apparatus characterizes that the electric mobility apparatus is loaded, wait for a first preset time to control the braking device of the electric mobility apparatus to be closed; and in response to determining that the operation information generated by the operation device of the electric mobility apparatus is empty and the usage information of the electric mobility apparatus characterizes that the electric mobility apparatus is not loaded, wait for a second preset time to control the braking device of the electric mobility apparatus to be closed. The first preset time may be greater than the second preset time.

FIG. 47 is a schematic diagram illustrating an exemplary structure of a control system for an electric mobility apparatus according to some embodiments of the present disclosure.

Some embodiments of the present disclosure further provide a control system for an electric mobility apparatus. As shown in FIG. 47, a control system 4700 may include an information acquisition module 4701, a command determination module 4702, and a control module 4703.

The information acquisition module 4701 may be configured to acquire input information of the electric mobility apparatus in a current operation mode. The command determination module 4702 may be configured to determine one or more control commands for the electric mobility apparatus based on the input information in the current operating mode. The control module 4703 may be configured to control the electric mobility apparatus to perform one or more actions based on the one or more control commands.

The control device 4100, the control device 4600, and the control system 4700 for the electric mobility apparatus according to some embodiments of the present disclosure may implement the control methods described in some embodiments of the present disclosure, and The above and other operations and/or functions of the various modules/units of the control device or the control system for the electric mobility apparatus may implement the corresponding processes in the embodiments shown in FIGS. 32-46, which are not repeated here for the sake of brevity.

FIG. 48 is a schematic diagram illustrating an exemplary structure of an electric mobility apparatus according to some embodiments of the present disclosure.

Some embodiments of the present disclosure further provide an electric mobility apparatus. The electric mobility apparatus may be configured to implement functions of a control device for the electric mobility apparatus 4800 in the embodiment shown in FIG. 48.

In some embodiments, as shown in FIG. 48, the electric mobility apparatus 4800 may include a bus 4801, a processor 4802, a communication interface 4803, and a storage device 4804. The processor 4802, the storage device 4804, and the communication interface 4803 may communicate with each other via the bus 4801.

The bus 4801 refers to a peripheral component interconnect (PCI) bus, an extended industry standard architecture (EISA) bus, etc. The bus may be categorized into an address bus, a data bus, a control bus, etc. For ease of illustration, the bus is represented by a single bold line in FIG. 48, but it does not mean that there is only one bus or one type of bus.

The processor 4802 may be a central processing unit (CPU), a graphics processing unit (GPU), a microprocessor (MP), a digital signal processor (DSP), or the like, or any combinations thereof.

The communication interface 4803 may be configured to communicate with the outside. For example, the communication interface 4803 may be configured to communicate with a terminal.

The storage device 4804 may include a volatile memory, such as random access memory (RAM). The storage device 4804 may also include non-volatile memory, such as read-only memory (ROM), flash memory, a hard disk drive (HDD), or a solid state drive (SSD).

The storage device 4804 may store executable codes. The processor 4802 may execute the codes to implement the foregoing control method for the electric mobility apparatus.

For example, in the case of implementing the embodiments illustrated in FIG. 41 and various modules or units of the control device 4100 for the electric mobility apparatus described in the embodiment of FIG. 41 being realized by software, the software or program codes required for executing the functions of the modules or units in FIG. 41 may be stored partially or wholly in the storage device 4804. The processor 4802 may implement the control method for the electric mobility apparatus by executing the program codes corresponding to the units stored in the storage device 4804.

Some embodiments of the present disclosure further provide a non-transitory computer-readable storage medium. The non-transitory computer-readable storage medium may be any available medium that a computing device can store or a data storage device, such as a data center, that contains one or more available media. The available medium may be a magnetic medium (e.g., a floppy disk, a hard disk, and a magnetic tape), an optical medium (e.g., a DVD), or a semiconductor medium (e.g., a solid state disk). The non-transitory computer-readable storage medium may include commands directing the computing device to perform the above control method for the electric mobility apparatus applied to the control device for the electric mobility apparatus.

Some embodiments of the present disclosure further provide a computer program product. The computer program product may include one or more computer commands. When the computer commands are loaded and executed on a computing device, processes or functions according to some embodiments of the present disclosure may be implemented in whole or in part.

The computer commands may be stored in the non-transitory computer-readable storage medium or transmitted from one non-transitory computer-readable storage medium to another non-transitory computer-readable storage medium. For example, the computer commands may be transmitted from one website, computer, or data center to another website site, computer, or data center through a wired mode (e.g., a coaxial cable, fiber optics, a digital subscriber line (DSL)) or a wireless mode (e.g., infrared, wireless, microwave, etc.).

When the computer program product is executed by the computer, the computer may be directed to implement any one of the foregoing control methods for the electric mobility apparatus. The computer program product may be a software installation package. In the event that any one of the foregoing control methods for the electric mobility apparatus is required, the software installation package may be downloaded to execute the computer program product on the on the computer.

It should be understood that the systems and modules thereof shown in FIG. 41, FIG. 46, and FIG. 47 may be implemented in various ways.

It should be noted that the above description of the control system and the modules/units thereof is provided for illustrative convenience only, and does not limit the present disclosure to the scope of the cited embodiments. It is understood that for a person skilled in the art, after understanding the principle of the system, it may be possible to arbitrarily combine the individual modules or form a sub-system to be connected to the other modules without departing from this principle. In some embodiments, the acquisition unit, the determination unit, and the control unit disclosed in FIG. 41 may be different modules in a single system, or a single module realizing the functions of two or more modules described above. For example, the individual modules may share a storage module, and the individual modules may each have a respective storage module. Such variations are within the scope of protection of the present disclosure.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

As another example, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A control method for an electric mobility apparatus, comprising:
obtaining input information of the electric mobility apparatus in a current operation mode;
determining one or more control commands for the electric mobility apparatus based on the input information in the current operation mode; and
controlling the electric mobility apparatus to perform one or more actions based on the one or more control commands.

2. The control method of claim 1, wherein the current operation mode includes a push mode, and the obtaining input information of the electric mobility apparatus in a current operation mode includes: obtaining force information input by a user to the electric mobility apparatus; and
the determining one or more control commands for the electric mobility apparatus based on the input information in the current operation mode includes: determining the one or more control commands based on the force information.

3. The control method of claim 2, wherein the obtaining force information input by a user to the electric mobility apparatus includes:
obtaining a first torque acting at a first position of the electric mobility apparatus; and/or
obtaining a second torque acting at a second location of the electric mobility apparatus.

4. The control method of claim 3, wherein the electric mobility apparatus includes a push device, and the first position and/or the second position are located on the push device.

5. The control method of claim 3, wherein the obtaining force information input by a user to the electric mobility apparatus includes:
in response to determining that the first torque and the second torque are obtained simultaneously, determining, based on a first relationship between a force direction characterized by the first torque and a force direction characterized by the second torque and a second relationship between a force magnitude characterized by the first torque and a force magnitude characterized by the second torque, a control command instructing the electric mobility apparatus to move.

6. The control method of claim 2, wherein the determining the one or more control commands based on the force information includes:
determining, based on a force magnitude characterized by the force information, a control command instructing a braking device of the electric mobility apparatus to perform an action.

7. The control method of claim 2, wherein the determining the one or more control commands based on the force information includes:
determining, based on the force information, a first control parameter for controlling a movement of the electric mobility apparatus in a linear direction and a second control parameter for controlling a movement of the electric mobility apparatus in a non-linear direction; and
determining the one or more control commands for the electric mobility apparatus based on the first control parameter and the second control parameter.

8. The control method of claim 2, wherein the determining the one or more control commands based on the force information includes:
in response to determining that the force information does not satisfy a preset condition, determining a control command instructing the electric mobility apparatus to stop moving; wherein the preset condition is a condition indicating a safe movement of the electric mobility apparatus.

9. The control method of claim 1, wherein the current operation mode includes a riding mode, the obtaining input information of the electric mobility apparatus in a current operation mode includes:
obtaining operation information input by the user to an operation device of the electric mobility apparatus; and
the determining one or more control commands for the electric mobility apparatus based on the input information includes:
obtaining a current velocity parameter of the electric mobility apparatus;
determining a current target acceleration based on the operation information and the current velocity parameter; and
determining the one or more control commands for the electric mobility apparatus based on the current target acceleration.

10. The control method of claim 9, wherein the determining the one or more control commands for the electric mobility apparatus based on the current target acceleration includes:
determining a current target velocity parameter of the electric mobility apparatus based on the current target acceleration; and
determining a target driving parameter for one or more driving devices of the electric mobility apparatus based on the current target velocity parameter of the electric mobility apparatus.

11. The control method of claim 1, wherein the obtaining input information of the electric mobility apparatus in a current operation mode includes:
detecting an operation mode currently executed by the electric mobility apparatus; and
obtaining the input information based on the operation mode currently executed by the electric mobility apparatus.

12. The control method of claim 11, wherein the detecting an operation mode currently executed by the electric mobility apparatus includes:
receiving a mode selection signal; and
determining, based on the mode selection signal, the operation mode currently executed by the electric mobility apparatus.

13. The control method of claim 1, further comprising:
obtaining related information of the electric mobility apparatus when the electric mobility apparatus is moving; wherein the related information includes at least one of load information of the electric mobility apparatus or road condition information corresponding to the electric mobility apparatus; and
adjusting the one or more control commands based on the related information.

14. A control system for an electric mobility apparatus, comprising:
an information acquisition module configured to obtain input information of the electric mobility apparatus in a current operation mode;
a command determination module configured to determine one or more control commands for the electric mobility apparatus based on the input information in the current operation mode; and
a control module configured to control the electric mobility apparatus to perform one or more actions based on the one or more control commands.

15. An electric mobility apparatus comprising a processor, wherein the processor is configured to:
obtain input information of the electric mobility apparatus in a current operation mode;
determine one or more control commands for the electric mobility apparatus based on the input information in the current operation mode; and
control the electric mobility apparatus to perform one or more actions based on the one or more control commands.

16. The electric mobility apparatus of claim 15, further comprising at least one of a push device or an operation device, the push device being provided with a force sensor or a torque sensor, and the operation device being configured to receive operation information.

17. The electric mobility apparatus of claim 15, further comprising:
a front wheel frame assembly including a seat surface bracket, the seat surface bracket including at least one unfolded state;
a rear wheel frame assembly connected to the front wheel frame assembly through at least one first rotational connection point;
a backrest bracket connected to the seat surface bracket through at least one second rotational connection point; and
a connecting member connected to the rear wheel frame assembly through at least one third rotational connection point and connected to the backrest bracket through at least one fourth rotational connection; wherein:
the first rotational connection point, second rotational connection point, third rotational connection point, and fourth rotational connection point are not located on a same straight line.

18. The electric mobility apparatus of claim 17, wherein in the unfolded state, the first rotational connection point and the third rotational connection point are located in front of the second rotational connection point and the fourth rotational connection point, the third rotational connection point and the fourth rotation connection point are located above the first rotational connection point and the second rotational connection point; a sum of a distance L1 between the first rotational connection point and the third rotational connection point and a distance L2 between the third rotational connection point and the fourth rotational connection point is less than a sum of a distance L3 between the second rotational connection point and the fourth rotational connection point and a distance L4 between the first rotational connection point and the second rotational connection point.

19. The electric mobility apparatus of claim 17, further comprising an operation device, wherein the front wheel frame assembly further includes a front frame and a front wheel, the front frame being rigidly connected to the seat surface bracket, the front wheel being connected to the front frame; and
the rear wheel frame assembly includes a rear frame, a rear wheel, and an armrest assembly, the rear frame being rotatably connected to the front frame at the first rotational connection point, the rear wheel being connected to the rear frame, the armrest assembly being connected to the rear frame, and the operation device being disposed on the armrest assembly.

20. The electric mobility apparatus of claim 19, further comprising a push device, wherein the push device includes one or more pushing handles, and at least one of the one or more pushing handles is provided with a force sensor or a torque sensor.
